(19) United States
(12) Patent Application Publication
(10) Pub. No.: US 2026/0370425 A1
(43) Pub. Date: Nov. 19, 2026

(54) CONTROL RESOURCE SET AND SEARCH SPACE CONFIGURATIONS FOR DIFFERENT DEVICE TYPES

(71) Applicant: QUALCOMM Incorporated, San Diego, CA (US)

(72) Inventors: Le LIU, San Jose, CA (US); Yan ZHOU, San Diego, CA (US); Alberto RICO ALVARINO, San Diego, CA (US); Yongle WU, San Diego, CA (US); Raghu Narayan CHALLA, Escondido, CA (US); Hari SANKAR, Poway, CA (US)

(21) Appl. No.: 19/663,093

(22) Filed: Apr. 29, 2026

Related U.S. Application Data
(60) Provisional application No. 63/807,099, filed on May 16, 2025.

(51) Int. Cl. H04L 5/00; H04L 27/26

(52) U.S. Cl. CPC H04L 5/0053; H04L 27/26025

(57) ABSTRACT

Various aspects of the present disclosure generally relate to wireless communication. In some aspects, a user equipment (UE) may receive, from a network node, system information that indicates a plurality of control resource set (CORESET) configurations and one or more search space configurations that are both used for a plurality of device types. The UE may receive, from the network node, a message using a first CORESET configuration from the plurality of CORESET configurations and a first search space configuration from the one or more search space configurations based on a device type of the UE from the plurality of device types. Numerous other aspects are described.

### CROSS-REFERENCE TO RELATED APPLICATION

This Patent application claims priority to U.S. Provisional Patent Application No. 63/807,099, filed on May 16, 2025, entitled “CONTROL RESOURCE SET AND SEARCH SPACE CONFIGURATIONS FOR DIFFERENT DEVICE TYPES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with control resource set and search space configurations for different device types.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, system information that indicates a plurality of control resource set (CORESET) configurations and one or more search space configurations that are both used for a plurality of device types. The processing system may be configured to cause the UE to receive, from the network node, a message using a first CORESET configuration from the plurality of CORESET configurations and a first search space configuration from the one or more search space configurations based at least in part on a device type of the UE from the plurality of device types.

Some aspects described herein relate to a network node. The network node may include a processing system. The processing system may include one or more processors and one or more code-storing memories coupled with the one or more processors. The processing system may be configured to cause the network node to transmit, to a UE, system information that indicates a plurality of CORESET configurations and one or more search space configurations that are both used for a plurality of device types. The processing system may be configured to cause the network node to transmit, to the UE, a message using a first CORESET configuration from the plurality of CORESET configurations and a first search space configuration from the one or more search space configurations based at least in part on a device type of the UE from the plurality of device types.

Some aspects described herein relate to a method of wireless communication performed by a UE. The method may include receiving, from a network node, system information that indicates a plurality of CORESET configurations and one or more search space configurations that are both used for a plurality of device types. The method may include receiving, from the network node, a message using a first CORESET configuration from the plurality of CORESET configurations and a first search space configuration from the one or more search space configurations based at least in part on a device type of the UE from the plurality of device types.

Some aspects described herein relate to a method of wireless communication performed by a network node. The method may include transmitting, to a UE, system information that indicates a plurality of CORESET configurations and one or more search space configurations that are both used for a plurality of device types. The method may include transmitting, to the UE, a message using a first CORESET configuration from the plurality of CORESET configurations and a first search space configuration from the one or more search space configurations based at least in part on a device type of the UE from the plurality of device types.

Some aspects described herein relate to a non-transitory computer-readable medium that stores a set of instructions for wireless communication by a UE. The set of instructions, when executed by one or more processors of the UE, may cause the UE to receive, from a network node, system information that indicates a plurality of CORESET configurations and one or more search space configurations that are both used for a plurality of device types. The set of instructions, when executed by one or more processors of the UE, may cause the UE to receive, from the network node, a message using a first CORESET configuration from the plurality of CORESET configurations and a first search space configuration from the one or more search space configurations based at least in part on a device type of the UE from the plurality of device types.

Some aspects described herein relate to a non-transitory computer-readable medium that stores a set of instructions for wireless communication by a network node. The set of instructions, when executed by one or more processors of the network node, may cause the network node to transmit, to a UE, system information that indicates a plurality of CORESET configurations and one or more search space configurations that are both used for a plurality of device types. The set of instructions, when executed by one or more processors of the network node, may cause the network node to transmit, to the UE, a message using a first CORESET configuration from the plurality of CORESET configurations and a first search space configuration from the one or more search space configurations based at least in part on a device type of the UE from the plurality of device types.

Some aspects described herein relate to an apparatus for wireless communication. The apparatus may include means for receiving, from a network node, system information that indicates a plurality of CORESET configurations and one or more search space configurations that are both used for a plurality of device types. The apparatus may include means for receiving, from the network node, a message using a first CORESET configuration from the plurality of CORESET configurations and a first search space configuration from the one or more search space configurations based at least in part on a device type of the apparatus from the plurality of device types.

Some aspects described herein relate to an apparatus for wireless communication. The apparatus may include means for transmitting, to a UE, system information that indicates a plurality of CORESET configurations and one or more search space configurations that are both used for a plurality of device types. The apparatus may include means for transmitting, to the UE, a message using a first CORESET configuration from the plurality of CORESET configurations and a first search space configuration from the one or more search space configurations based at least in part on a device type of the UE from the plurality of device types.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a synchronization signal hierarchy.

FIG. 3 is a diagram illustrating an example of a 20 physical resource block (20-PRB) synchronization signal block (SSB).

FIG. 4 is a diagram illustrating an example of a timing diagram including multiple repetitions of a 20-PRB SSB.

FIG. 5 is a diagram illustrating an example resource structure for wireless communication.

FIG. 6 is a diagram illustrating an example for wireless communication of an SSB and a control resource set (CORESET).

FIG. 7 is a diagram illustrating an example of a search space for a monitoring occasion.

FIGS. 8A through 8C are diagrams illustrating examples associated with different CORESET and search space configurations used by different types of wireless devices.

FIG. 9 is a diagram illustrating an example associated with different CORESET and search space configurations used by different types of wireless devices.

FIG. 10 is a diagram illustrating an example associated with resource block boundary alignment for different CORESET configurations used by different types of wireless devices.

FIG. 11 is a diagram illustrating an example associated with resource block boundary alignment for different CORESET configurations used by different types of wireless devices.

FIGS. 12A and 12B are diagrams illustrating examples associated with subcarrier-spacing for different CORESET configurations used by different types of wireless devices.

FIG. 13 is a diagram illustrating an example associated with resource block offsets for different CORESET configurations used by different types of wireless devices.

FIG. 14 is a diagram illustrating an example associated with multiple resource block offsets for a CORESET0b.

FIGS. 15A and 15B are diagrams illustrating examples associated with control channel element to resource element group mapping interleaving patterns for different CORESET configurations.

FIG. 16 is a diagram illustrating an example associated with precoding different CORESETs used by different types of wireless devices.

FIG. 17 is a diagram illustrating an example associated with different entries of a master information block (MIB) indication to jointly indicate different CORESET configurations.

FIG. 18 is a diagram illustrating an example associated with different entries of an MIB indication to jointly indicate different search space configurations.

FIG. 19 is a diagram of an example associated with signaling that enables CORESET and search space configurations for different device types.

FIG. 20 is a diagram illustrating an example process performed, for example, at a user equipment (UE) or an apparatus of a UE.

FIG. 21 is a diagram illustrating an example process performed, for example, at a network node or an apparatus of a network node.

FIG. 22 is a diagram of an example apparatus for wireless communication.

FIG. 23 is a diagram of an example apparatus for wireless communication.

### DETAILED DESCRIPTION

Wireless communication systems aim to accommodate a diverse range of user equipment (UE) types with varying capabilities. These systems must support devices with differing bandwidth capabilities and computational resources while providing consistent and reliable communication performance across all device types. For example, enhanced mobile broadband (eMBB) devices may have wide bandwidth capabilities (e.g., 5 MHz or more) and are designed for high data rate applications, whereas internet of things (IoT) devices, including reduced-capability and low-end IoT devices, may have limited bandwidth capabilities (e.g., 3 MHz or 1.4 MHz) and are designed for cost-effective, low-power applications.

In some wireless communications systems (e.g., fifth generation (5G) networks), low-end IoT devices may not be directly supported within a unified framework. This creates challenges for integrating such devices into networks in a manner that is both efficient and scalable. In some other wireless communications systems (e.g., sixth generation (6G) networks), however, there is a desire to provide a harmonized, forward-compatible design that supports a wide range of device types, including eMBB devices and various categories of IoT devices. One challenge in such unified designs involves the handling of synchronization signal blocks (SSBs) and control resource sets (CORESETs). SSBs are used for initial access by UEs to a cell of a network and provide synchronization and broadcast information used by the UEs to perform cell access. CORESETs define the resources used for a physical downlink control channel (PDCCH), which carries control information such as scheduling and system configuration data. In systems with UEs of varying bandwidth capabilities, ensuring that all devices can reliably decode SSBs and access CORESETs presents technical difficulties. For example, an SSB may span 20 physical resource blocks (PRBs), which can be decoded by wide-bandwidth devices but may exceed the bandwidth capabilities of narrower-bandwidth devices. Similarly, CORESETs may include configuration adjustments to enable devices with limited bandwidth to monitor PDCCHs effectively. Another technical challenge arises from maintaining consistent communication performance across devices with differing capabilities. Devices with lower bandwidth capabilities may utilize adjustments to CORESET configurations, such as reducing the number of resource blocks (RBs) or increasing symbol duration, to ensure adequate link budget and reliability. However, such adjustments can complicate resource management and signaling overhead, particularly in scenarios where multiple device types coexist within the same network. Furthermore, ensuring compatibility across devices can introduce complexity into signaling mechanisms, particularly for master information block (MIB) signaling and PDCCH signaling. For example, devices of different types may use different subcarrier-spacings (SCSs), RB offsets, and interleaving patterns for CORESET configuration. These variations are conveyed through signaling mechanisms, which may introduce excessive complexity or increasing latency. Additionally, devices with narrow bandwidth may retune to different parts of the SSB or CORESET over multiple monitoring occasions (MOs), potentially impacting latency and overall network efficiency.

Various aspects relate generally to enabling a unified and forward-compatible design for wireless communication systems to support diverse device types with varying bandwidth capabilities. Some aspects more specifically relate to techniques in which a UE receives system information (via an SSB) from a network node indicating a plurality of CORESET configurations (e.g., CORESET0, CORESET0a, and CORESET0b) and one or more search space configurations (e.g., a common search space or one or more respective search spaces respectively mapped to CORESET0, CORESET0a, and CORESET0b). These configurations are used for a plurality of device types, allowing the UE to monitor a CORESET and receive a message based on a CORESET configuration and a search space configuration corresponding to a device type of the UE.

In some aspects, the system information may indicate MOs that are common across multiple device types, MOs specifically associated with different device types, or a combination of both. Additionally, the system information may define CORESET configurations with aligned or non-aligned RB boundaries relative to SSBs, as well as CORESET configurations that share a common SCS or use different SCSs. The system information may further include RB offsets, interleaving patterns, precoding schemes, and aggregation levels tailored for respective CORESET configurations to optimize communication performance across different devices. For devices with limited bandwidth, the system may configure CORESETs with longer durations in terms of OFDM symbols, associated with a search space set using intra-slot and/or inter-slot repetitions, and DMRS bundling, or MOs that enable retuning across subsets of the CORESET resources, ensuring accessibility and reliability. The network may determine to retain the PDCCH repetitions in the CORESET0 to be unchanged so that the devices with limited bandwidth and/or limited receive antennas can combine the PDCCH to improve the coverage.

Particular aspects of the subject matter described herein can be implemented to realize one or more of the following potential advantages. By providing system information that defines CORESET and search space configurations for diverse device types, the described techniques enable efficient allocation of communication resources for devices with varying bandwidth, computational, and resource capabilities. For example, low-end IoT devices with restricted bandwidth can monitor tailored CORESET configurations, reducing resource consumption while enabling the decoding of control information such as scheduling and system configuration data. Additionally, high-bandwidth devices can utilize broader CORESET configurations to maximize communication throughput, optimizing spectral efficiency and signal quality. In some aspects, the use of configurable CORESET and search space parameters minimizes signaling overhead, conserves network resources, and reduces computational complexity. For example, by jointly indicating multiple parameters per CORESET configuration or search space configuration in the system information, the network can efficiently convey configuration details to multiple devices of varying capabilities while reducing signaling traffic. This approach may conserve processing resources, memory resources, and network resources in both the network and the devices. Additionally, by enabling tailored CORESET configurations with features such as longer durations in terms of OFDM symbols, associated with a search space set using intra-slot and/or inter-slot repetitions, and DMRS bundling, increased aggregation levels, and interleaving patterns optimized for narrower bandwidths, the system improves link budget performance and reliability for low-end IoT devices. Flexible precoding schemes and SCS options enhance spectral efficiency for high-bandwidth devices, optimizing resource utilization across the network. In this way, the described techniques may conserve communication resources, reduce latency, and mitigate signal interference while ensuring adaptability to diverse device requirements. Overall, these techniques enable wireless communication systems to provide a scalable, harmonized design optimized for diverse device types, including eMBB devices and various categories of IoT devices. By supporting a wide range of device capabilities within a unified framework, the system achieves improved spectral efficiency, reduced signaling complexity, and conservation of network and device resources, while ensuring energy-efficient operation for both devices and the network infrastructure.

5G New Radio (NR) may support eMBB access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

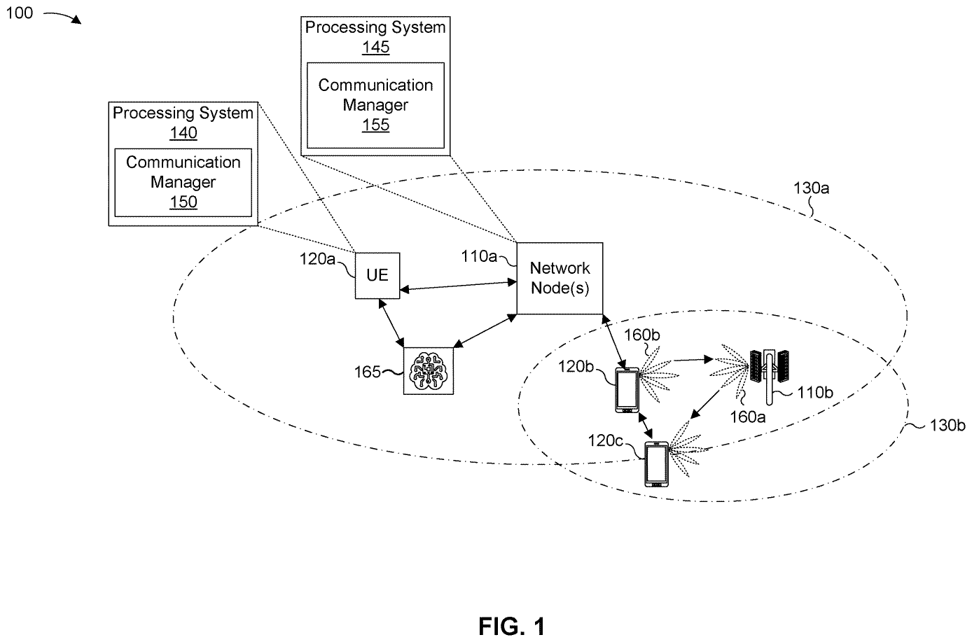

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, RBs, and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node, system information that indicates a plurality of CORESET configurations and one or more search space configurations that are both used for a plurality of device types; and receive, from the network node, a message using a first CORESET configuration from the plurality of CORESET configurations and a first search space configuration from the one or more search space configurations based at least in part on a device type of the UE from the plurality of device types. Additionally, or alternatively, the communication manager 150 may perform one or more other operations described herein.

In some aspects, the network node 110 may include a communication manager 155. As described in more detail elsewhere herein, the communication manager 155 may transmit, to a UE, system information that indicates a plurality of CORESET configurations and one or more search space configurations that are both used for a plurality of device types; and transmit, to the UE, a message using a first CORESET configuration from the plurality of CORESET configurations and a first search space configuration from the one or more search space configurations based at least in part on a device type of the UE from the plurality of device types. Additionally, or alternatively, the communication manager 155 may perform one or more other operations described herein.

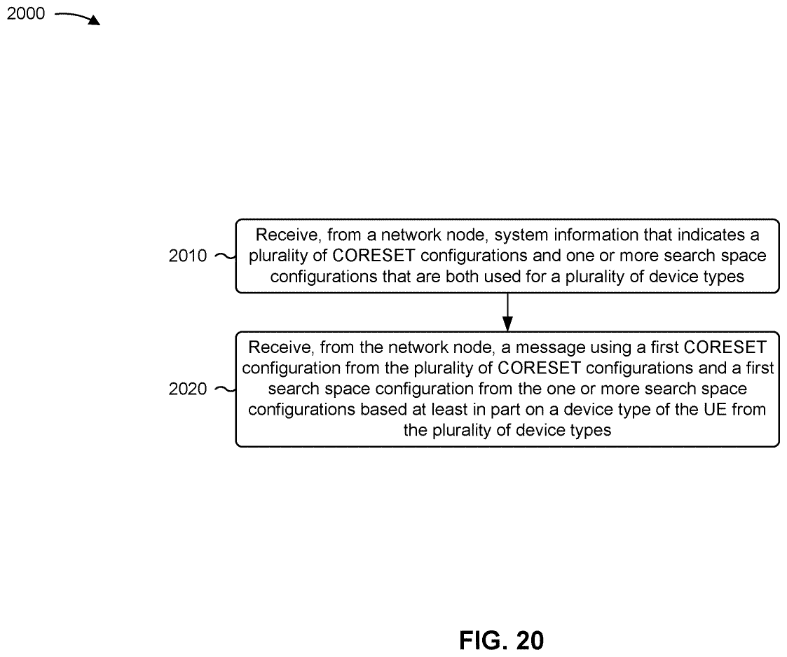

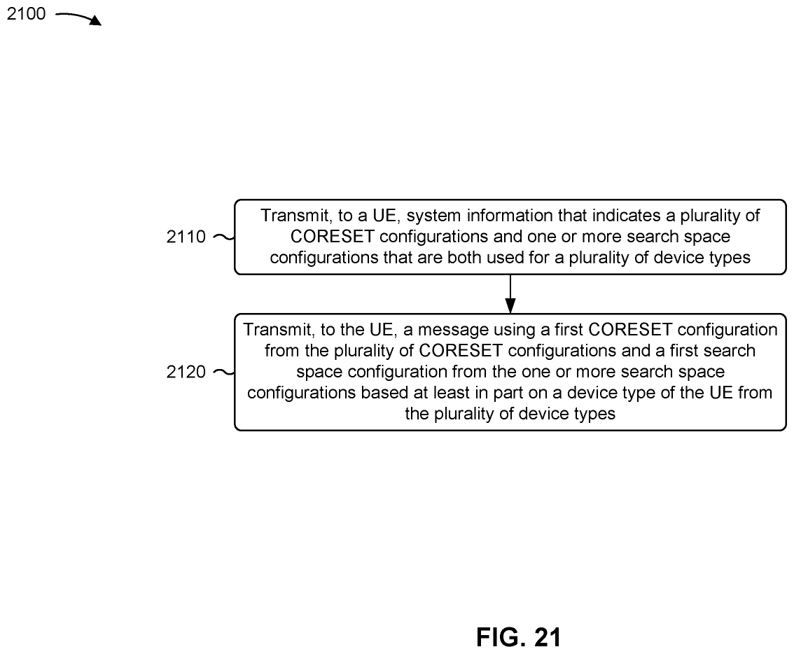

The network node 110, the processing system 145 of the network node 110, the UE 120, the processing system 140 of the UE 120, or any other component(s) of FIG. 1 may implement one or more techniques or perform one or more operations associated with CORESET and search space configurations for different device types, as described in more detail elsewhere herein. For example, the processing system 145 of the network node 110, or the processing system 140 of the UE 120 may perform or direct operations of, for example, process 2000 of FIG. 20, process 2100 of FIG. 21, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 2000 of FIG. 20, process 2100 of FIG. 21, or other processes as described herein. In some examples, executing instructions may include running the instructions, converting the instructions, compiling the instructions, or interpreting the instructions, among other examples.

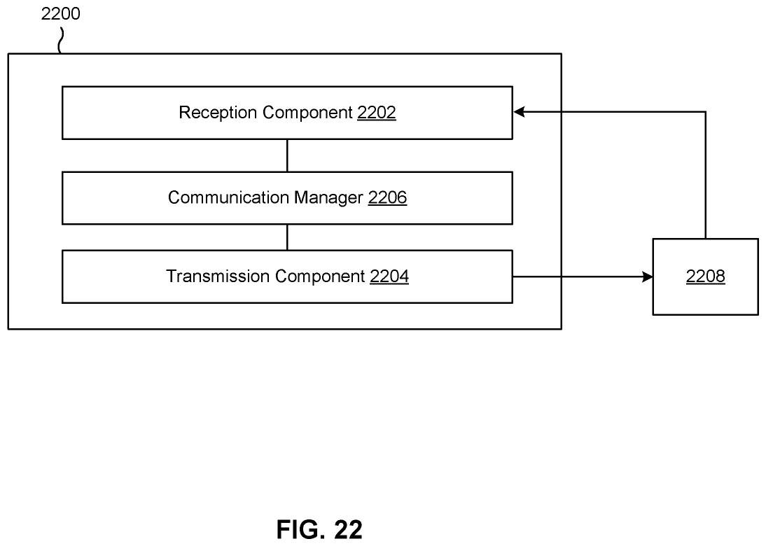

In some aspects, the UE 120 includes means for receiving, from a network node, system information that indicates a plurality of CORESET configurations and one or more search space configurations that are both used for a plurality of device types; or means for receiving, from the network node, a message using a first CORESET configuration from the plurality of CORESET configurations and a first search space configuration from the one or more search space configurations based at least in part on a device type of the UE from the plurality of device types. The means for the UE 120 to perform operations described herein may include, for example, one or more of communication manager 150, processing system 140, a radio, one or more RF chains, one or more transceivers, one or more antennas, one or more modems, a reception component (for example, reception component 2202 depicted and described in connection with FIG. 22), or a transmission component (for example, transmission component 2204 depicted and described in connection with FIG. 22), among other examples.

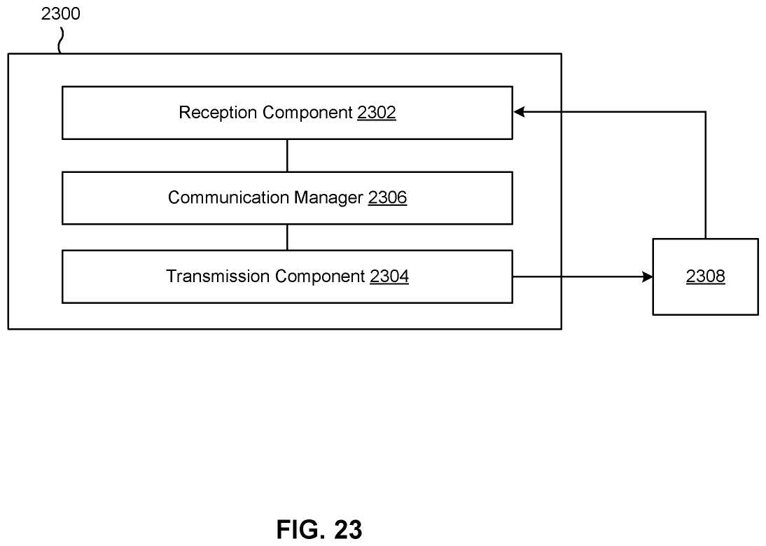

In some aspects, the network node 110 includes means for transmitting, to a UE, system information that indicates a plurality of CORESET configurations and one or more search space configurations that are both used for a plurality of device types; or means for transmitting, to the UE, a message using a first CORESET configuration from the plurality of CORESET configurations and a first search space configuration from the one or more search space configurations based at least in part on a device type of the UE from the plurality of device types. The means for the network node 110 to perform operations described herein may include, for example, one or more of communication manager 155, processing system 145, a radio, one or more RF chains, one or more transceivers, one or more antennas, one or more modems, a reception component (for example, reception component 2302 depicted and described in connection with FIG. 23), or a transmission component (for example, transmission component 2304 depicted and described in connection with FIG. 23), among other examples.

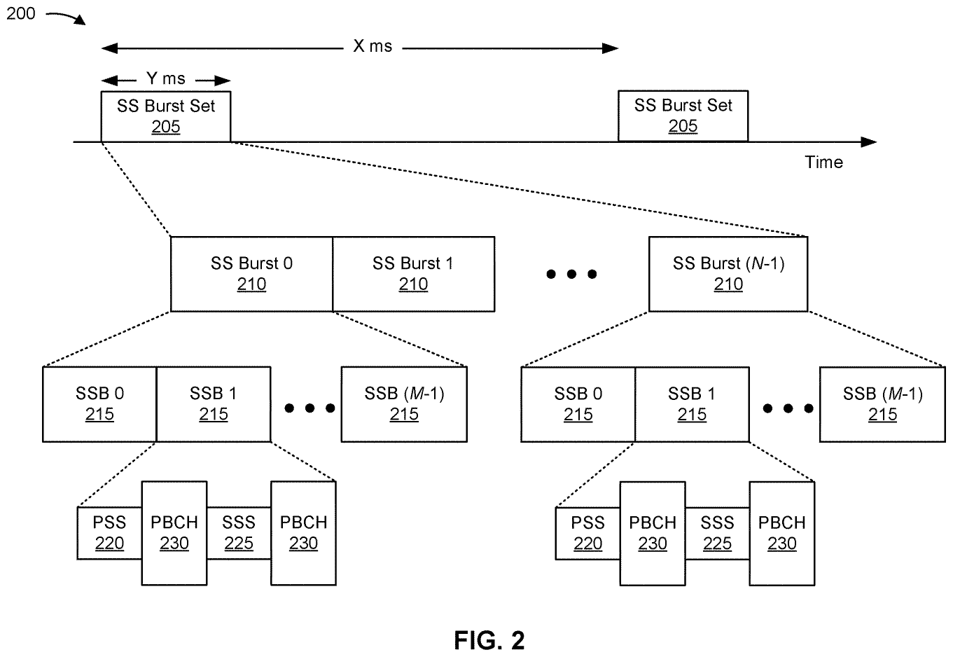

FIG. 2 is a diagram illustrating an example 200 of a synchronization signal (SS) hierarchy. As shown in FIG. 2, the SS hierarchy may include an SS burst set 205, which may include multiple SS bursts 210, shown as SS burst 0 through SS burst N−1, where Nis a maximum number of repetitions of the SS burst 210 that may be transmitted by one or more network nodes. As further shown, each SS burst 210 may include one or more SS blocks (SSBs) 215, shown as SSB 0 through SSB M−1, where M is a maximum number of SSBs 215 that can be carried by an SS burst 210. In some aspects, different SSBs 215 may be beam-formed differently (e.g., transmitted using different beams), and may be used for cell search, cell acquisition, beam management, or beam selection (e.g., as part of an initial network access procedure). An SS burst set 205 may be periodically transmitted by a wireless node (e.g., a network node 110), such as every X milliseconds, as shown in FIG. 2. In some aspects, an SS burst set 205 may have a fixed or dynamic length, shown as Y milliseconds in FIG. 2. In some cases, an SS burst set 205 or an SS burst 210 may be referred to as a discovery reference signal (DRS) transmission window or an SSB measurement time configuration (SMTC) window.

In some aspects, an SSB 215 may include resources that carry a primary synchronization signal (PSS) 220, a secondary synchronization signal (SSS) 225, or a physical broadcast channel (PBCH) 230. In some aspects, multiple SSBs 215 are included in an SS burst 210 (e.g., with transmission on different beams), and the PSS 220, the SSS 225, or the PBCH 230 may be the same across each SSB 215 of the SS burst 210. In some aspects, a single SSB 215 may be included in an SS burst 210. In some aspects, the SSB 215 may be at least four symbols (e.g., OFDM symbols) in length, where each symbol carries one or more of the PSS 220 (e.g., occupying one symbol), the SSS 225 (e.g., occupying one symbol), or the PBCH 230 (e.g., occupying two symbols). In some aspects, an SSB 215 may be referred to as an SS/PBCH block.

In some aspects, the symbols of an SSB 215 are consecutive, as shown in FIG. 2. In some aspects, the symbols of an SSB 215 are non-consecutive. Similarly, in some aspects, one or more SSBs 215 of the SS burst 210 may be transmitted in consecutive radio resources (e.g., consecutive symbols) during one or more slots. Additionally, or alternatively, one or more SSBs 215 of the SS burst 210 may be transmitted in non-consecutive radio resources.

In some aspects, the SS bursts 210 may have a burst period, and the SSBs 215 of the SS burst 210 may be transmitted by a wireless node (e.g., a network node 110) according to the burst period. In this case, the SSBs 215 may be repeated during each SS burst 210. In some aspects, the SS burst set 205 may have a burst set periodicity, whereby the SS bursts 210 of the SS burst set 205 are transmitted by the wireless node according to the fixed burst set periodicity. In other words, the SS bursts 210 may be repeated during each SS burst set 205.

In some aspects, an SSB 215 may include an SSB index, which may correspond to a beam used to carry the SSB 215. A UE 120 may monitor for or measure SSBs 215 using different receive (Rx) beams during an initial network access procedure or a cell search procedure, among other examples. Based at least in part on the monitoring or measuring, the UE 120 may indicate one or more SSBs 215 with a best signal parameter (e.g., a reference signal received power (RSRP) parameter) to a network node 110 (e.g., directly or via one or more other network nodes). The network node 110 and the UE 120 may use the one or more indicated SSBs 215 to select one or more beams to be used for communication between the network node 110 and the UE 120 (e.g., for a random access channel (RACH) procedure). Additionally, or alternatively, the UE 120 may use the SSB 215 or the SSB index to determine a cell timing for a cell via which the SSB 215 is received (e.g., a serving cell).

As indicated above, FIG. 2 is provided as an example. Other examples may differ from what is described with regard to FIG. 2.

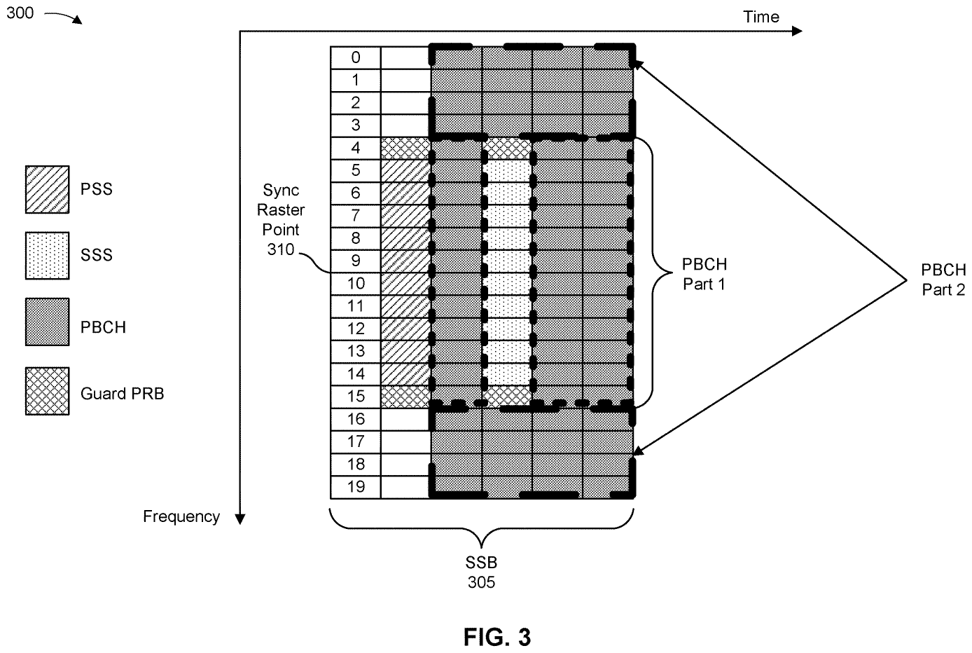

FIG. 3 is a diagram illustrating an example 300 of a 20-PRB SSB. In some instances, example 300 may implement or be implemented by one or more aspects or wireless communication network 100 and example 200. For example, an SSB 305 may be an example of an SSB 215. Additionally, as shown in FIG. 3, the SSB includes a PSS, a PBCH, and an SSS, as described herein (e.g., with reference to FIG. 2).

As shown by FIG. 3, and example 300, the SSB 305 represents a 20-PRB SSB, which incorporates a PSS, an SSS, and a PBCH as described herein. The PSS and SSS are carried within a 12-PRB bandwidth, while the PBCH is comprised of two parts. For example, as shown in FIG. 3, a PBCH part 1 shares the 12-PRB bandwidth with the PSS/SSS and PBCH part 2 extends beyond the bandwidth of the PSS/SSS to an additional 8-PRB, as illustrated in FIG. 3. A PRB in wireless communication is a unit of resource allocation in the frequency domain, spanning a consecutive set of subcarriers within a given time slot. PRBs are used to allocate bandwidth for data transmission between the network and wireless devices (e.g., UEs)

As shown in FIG. 3, the SSB 305 includes multiple guard PRBs. Guard PRBs are reserved frequency resources that serve as buffers or protective bands around the active transmission channels. These guard bands help prevent interference between adjacent frequency channels by providing a buffer zone that reduces the likelihood of signal overlap or leakage. In the context of the SSB 305, the guard PRBs ensure that the synchronization signals, such as the PSS, SSS, and PBCH, are transmitted without interference from neighboring channels. Accordingly, the guard PRBs assist in maintaining the integrity and clarity of the synchronization signals, which increases network stability.

As shown in FIG. 3, SSB 305 includes a synchronization raster point 310 between PRB 9 and PRB 10. For example, the synchronization raster point 310 serves as a reference marker within the frequency domain, aiding in the alignment of signal transmission timing across a wireless communication network. Additionally, the synchronization raster point 310 ensures that the synchronization signals, such as the PSS and SSS, are transmitted at precise intervals, facilitating accurate cell search and acquisition by the UE 120. This alignment maintains stability and efficiency, allowing different devices to synchronize operations with the timing of the network, thereby enhancing overall communication performance. Additionally, the synchronization raster point 310 helps in managing frequency offsets and inter-cell synchronization, contributing to a more robust and reliable network infrastructure.

In some aspects, encoded PBCH bits can be first mapped to the resources of PBCH part 1 and then mapped to PBCH part 2, or the encoded PBCH bits may be repeated across both parts of PBCH RBs. Additionally, or alternatively, instead of mapping encoded PBCH bits first to the resources of PBCH part 1 and then to PBCH part 2, the encoded bits may be distributed dynamically based on network demand, optimizing resource utilization. This dynamic distribution can help manage network resources more efficiently, especially in high-traffic scenarios, ensuring that bandwidth is used effectively to meet user demands.

In some examples, different types of wireless devices or UEs may be capable of decoding across different bandwidths of the frequency domain. For example, devices or UEs with a bandwidth of 3 MHz may decode the PSS and SSS signals, and PBCH part 1 (e.g., exclude the resources of PBCH part 2) for reduced complexity in certain low-bandwidth scenarios, simplifying the decoding process and conserving power. Additionally, or alternatively, devices or UEs with a bandwidth greater than or equal to 5 MHz may use an alternative method of combining PBCH LLRs from both the PBCH part 1 and part 2, such as weighted averaging, to improve signal decoding performance. This method of combining PBCH LLRs can offer enhanced decoding accuracy and robustness against signal fluctuations.

The setup of the SSB 305 to include multiple parts of the PBCHs enhances spectral efficiency and provides broader channel bandwidth support for wireless devices of varying bandwidth capabilities, facilitating improved coverage and cell-edge performance in wireless communication networks. Additionally, or alternatively, the configuration may support adaptive spectral efficiency, allowing network operators to dynamically adjust bandwidth and synchronization parameters based on real-time traffic and environmental conditions. This adaptability ensures that network resources are allocated optimally, enhancing overall performance and user experience. Additionally, or alternatively, the setup may incorporate advanced signal processing techniques, such as multi-antenna reception, to further enhance cell-edge performance and coverage in challenging deployment scenarios. These techniques can significantly improve signal quality and reliability, particularly in areas with difficult propagation conditions, ensuring consistent and high-quality communication services.

As indicated above, FIG. 3 is provided as an example. Other examples may differ from what is described with regard to FIG. 3.

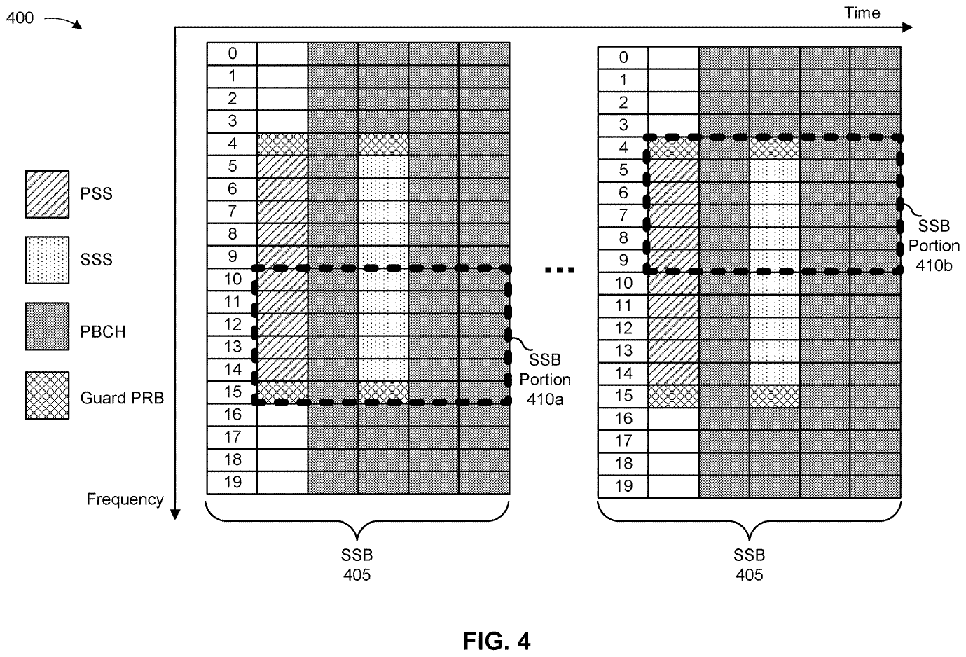

FIG. 4 is a diagram illustrating an example 400 of a timing diagram including multiple repetitions of a 20-PRB SSB. In some instances, example 400 may implement or be implemented by one or more aspects or wireless communication network 100, example 200, and example 300. For example, an SSB 405 may be an example of an SSB 305. As shown by FIG. 4, and example 400, the SSB 405 represents multiple repetitions of a 20-PRB SSB, which incorporates a PSS, an SSS, and a PBCH as described herein (e.g., the same as SSB 305). The PSS and SSS are carried within a 12-PRB bandwidth, while the PBCH is comprised of two parts, as described herein (e.g., with reference to FIG. 3).

Additionally, FIG. 4 illustrates multiple repetitions of the SSB 405 enabling a wireless device or UE to decode different portions of the SSB 405 during the different repetitions. For example, in scenarios where a device or UE operates with a low bandwidth (e.g., bandwidth of 1.4 MHz), the UE may be configured to decode a portion of the synchronization signals per repetition of the SSB 405 (e.g., specifically half of the PSS, SSS, and PBCH part 1 per SSB repetition). This selective decoding is tailored to accommodate the limited bandwidth capabilities of the low bandwidth UE, ensuring that the UE can effectively engage with the network without being overwhelmed by the full spectrum of signals. By focusing on half of the PSS and SSS, the low bandwidth UE can achieve synchronization and cell search functionalities.

The low bandwidth UE may employ a tuning mechanism to access the PBCH encoded bits. Initially, as shown in FIG. 4, the low bandwidth UE tunes to the bottom 6-PRB segment of PBCH part 1 (e.g., PRBs 10 through 15) to retrieve the SSB portion 410a of the encoded bits. Subsequently, the low bandwidth UE adjusts its tuning to the top 6-PRB segment of PBCH part 1 (e.g., PRBs 4 through 9) to acquire the SSB portion 410b of the encoded bits. This sequential tuning approach enables the low bandwidth UE to piece together the complete set of broadcast information from PBCH part 1. By optimizing the decoding process to handle only a portion of the available signals, the low bandwidth UE can conserve energy and reduce processing demands, enhancing its operational efficiency. Additionally, this approach allows the network to accommodate a diverse range of devices with varying bandwidth capabilities, promoting inclusivity and broadening the reach of wireless communication services.

As indicated above, FIG. 4 is provided as an example. Other examples may differ from what is described with regard to FIG. 4.

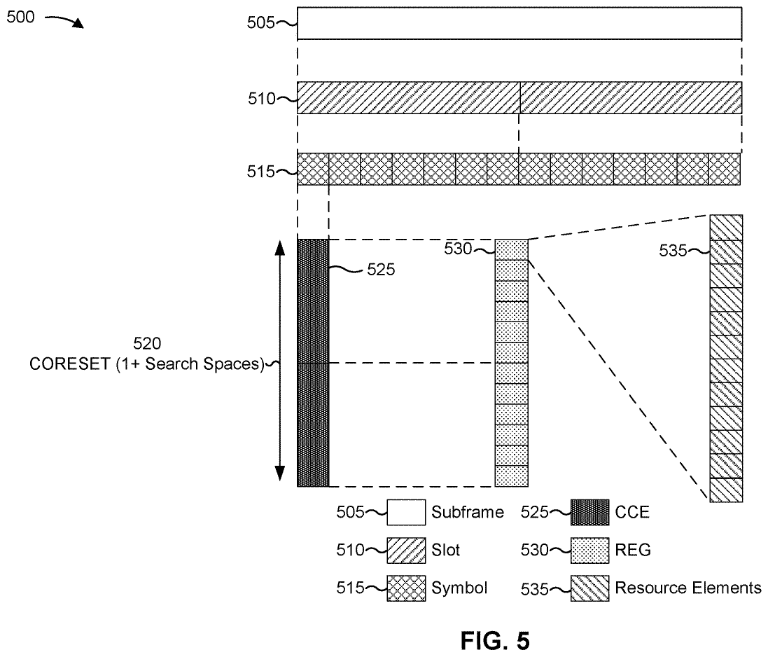

FIG. 5 is a diagram illustrating an example resource structure 500 for wireless communication. Resource structure 500 shows an example of various groups of resources described herein. As shown, resource structure 500 may include a subframe 505. Subframe 505 may include multiple slots 510. While resource structure 500 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes or slots. A slot 510 may include multiple symbols 515, such as 14 symbols per slot.

The potential control region of a slot 510 may be referred to as a CORESET 520 and may be structured to support an efficient use of resources, such as by flexible configuration or reconfiguration of resources of the CORESET 520 for one or more PDCCHs or one or more physical downlink shared channels (PDSCHs). In some aspects, the CORESET 520 may occupy the first symbol 515 of a slot 510, the first two symbols 515 of a slot 510, or the first three symbols 515 of a slot 510. Thus, a CORESET 520 may include multiple RBs in the frequency domain, and either one, two, or three symbols 515 in the time domain. In 5G, a quantity of resources included in the CORESET 520 may be flexibly configured, such as by using radio resource control (RRC) signaling to indicate a frequency domain region (e.g., a quantity of RBs) or a time domain region (e.g., a quantity of symbols) for the CORESET 520.

As illustrated, a symbol 515 that includes CORESET 520 may include one or more control channel elements (CCEs) 525, shown as two CCEs 525 as an example, that span a portion of the system bandwidth. A CCE 525 may include downlink control information (DCI) that is used to provide control information for wireless communication. A network node may transmit DCI during multiple CCEs 525 (as shown), where the quantity of CCEs 525 used for transmission of DCI represents the aggregation level (AL) used by the BS for the transmission of DCI. In FIG. 5, an aggregation level of two is shown as an example, corresponding to two CCEs 525 in a slot 510. In some aspects, different aggregation levels may be used, such as 1, 2, 4, 8, 16, or another aggregation level.

Each CCE 525 may include a fixed quantity of resource element groups (REGs) 530, shown as 6 REGs 530, or may include a variable quantity of REGs 530. In some aspects, the quantity of REGs 530 included in a CCE 525 may be specified by a REG bundle size. A REG 530 may include one RB, which may include 12 resource elements (REs) 535 within a symbol 515. A resource element 535 may occupy one subcarrier in the frequency domain and one OFDM symbol in the time domain.

A search space may include all possible locations (e.g., in time or frequency) where a PDCCH may be located. A CORESET 520 may include one or more search spaces, such as a UE-specific search space, a group-common search space, or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) or an aggregation level being used. A possible location (e.g., in time or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 520 may be interleaved or non-interleaved. An interleaved CORESET 520 may have CCE-to-REG mapping such that adjacent CCEs are mapped to scattered REG bundles in the frequency domain (e.g., adjacent CCEs are not mapped to consecutive REG bundles of the CORESET 520). A non-interleaved CORESET 520 may have a CCE-to-REG mapping such that all CCEs are mapped to consecutive REG bundles (e.g., in the frequency domain) of the CORESET 520.

As indicated above, FIG. 5 is provided as an example. Other examples may differ from what is described with respect to FIG. 5.

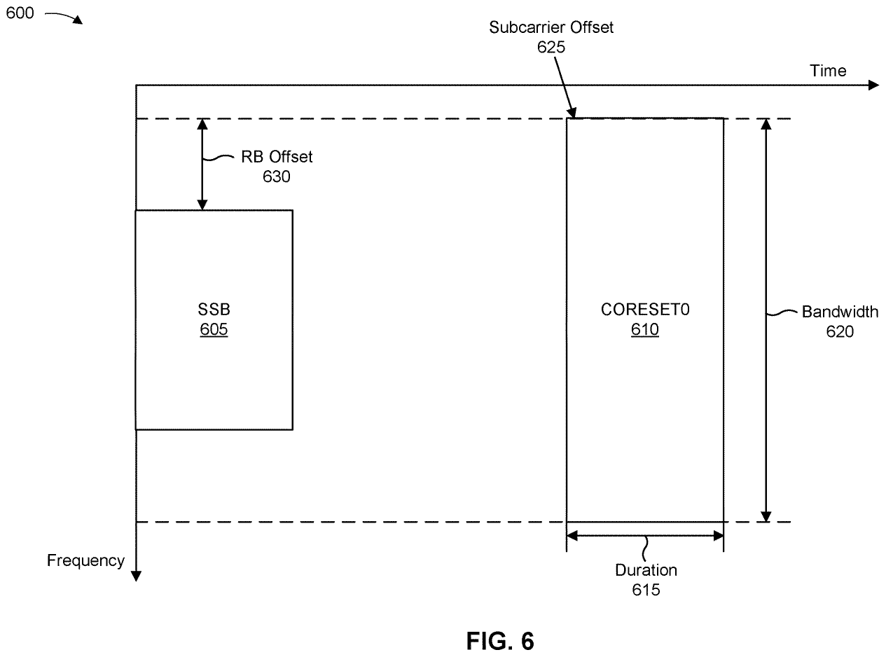

FIG. 6 is a diagram illustrating an example 600 for wireless communication of an SSB and a CORESET. Example 600 may implement or be implemented by one or more aspects of wireless communication network 100 and examples 200 through 500. For example, a CORESET0 610 may be an example of the CORESET 520 and the SSB 605 may be an example of one or more SSBs provided herein.

In example 600, the CORESET0 610 may be configured in relation to the SSB 605. The CORESET0 610 may be a control resource set in a wireless communication network used for PDCCH monitoring. For example, as illustrated, CORESET0 610 has specific parameters such as a duration 615, a bandwidth 620, and a subcarrier offset 625 (e.g., k_SSB) relative to the SSB 605.

In some aspects, CORESET0 610 may be configured based on predefined network parameters, which include SCS and multiplexing patterns. This configuration allows for standardized alignment and integration within the network, ensuring consistent performance across various network setups. Additionally, or alternatively, configuration of CORESET0 610 may include setting specific parameters through network control elements, such as a base station controller or a radio network controller. This enables dynamic adjustments and fine-tuning of CORESET0 610 characteristics to meet specific network demands and optimize control resource allocation.

As shown further, CORESET0 610 includes the duration 615 that defines the time span over which CORESET0 610 resources are available for one or more PDCCH transmissions. In some aspects, the duration 615 of CORESET0 may be dynamically adjusted according to real-time network traffic conditions or user demand. This dynamic adjustment allows the network to respond to fluctuating traffic patterns, ensuring that control channel resources are efficiently utilized without unnecessary waste. Additionally, or alternatively, the duration 615 may be configured through adaptive algorithms that optimize the time span for PDCCH transmission based on historical network data and predictive modeling.

Additionally, CORESET0 610 may be characterized by the bandwidth 620, which represents the frequency range allocated for control signaling. In some aspects, the bandwidth 620 for CORESET0 610 may be allocated using a flexible resource management approach, where bandwidth can be expanded or contracted based on the characteristics of a control channel, such as data throughput for the control channel. This flexibility allows for efficient use of spectral resources, adapting to changing network conditions and requirements. Additionally, or alternatively, instead of a fixed number of RBs, the bandwidth 620 configuration may utilize a variable bandwidth assignment strategy that allocates frequency space on an as-needed basis. Such a strategy ensures optimal utilization of available bandwidth, providing the necessary space for control operations while maintaining network efficiency.

As shown further, CORESET0 610 is aligned with the subcarrier offset 625 (k_SSB), which indicates the lowest subcarrier offset of the CORESET0 610 relative to the SSB 605 (e.g., the lowest RB of the CORESET 610 relative to a smallest RB index of a common RB overlapping with the lowest RB of the SSB 605). In some aspects, the subcarrier offset 625 may be adapted to account for changes in network topology or synchronization signal block configurations. This adaptation ensures that the CORESET0 610 remains properly aligned with the SSB 605 according to variations in network structure or signal block characteristics. Additionally, or alternatively, instead of using a fixed offset, an adaptive offset mechanism may be employed to dynamically align the CORESET0 610 with shifting a frequency range of the SSB 605. An adaptive mechanism provides real-time adjustments to subcarrier alignment, maintaining robust synchronization and minimizing interference.

Moreover, the CORESET0 610 has an RB offset 630, which defines the positional offset of the first RB in CORESET0 relative to the RBs of the SSB 605. In some aspects, the RB offset 630 may be determined through a predictive mapping technique that anticipates shifts in SSB RB positions. Predictive mapping allows the network to proactively adjust CORESET0 610 positioning, ensuring optimal alignment with SSB resources for enhanced performance.

In some aspects, CORESET0 610 may incorporate advanced precoding techniques to enhance signal quality and reduce interference within the control resource set. This incorporation of advanced techniques can significantly improve the reliability and effectiveness of control signaling in complex network environments. Additionally, or alternatively, alternative multiplexing patterns for CORESET0 may be used to improve integration with SSB and optimize network signaling efficiency. Exploring multiplexing alternatives offers opportunities to refine network operations, ensuring seamless communication between CORESET0 610 and SSB 605.

As described herein, one or more parameters for the CORESET 610 (e.g., the duration 615, bandwidth 620, subcarrier offset 625, or RB offset 630) may be indicated via a master information block (MIB) of the SSB 605. Additionally, or alternatively, the MIB may indicate other parameters of the CORESET0 610, including one or more of a CORESET0 610 SCS (e.g., one of two SCS candidates per FR1 or FR2), a CORESET0 610 RB number (e.g., the bandwidth 620), a CORESET0 610 symbol number (e.g., the duration 615), or a CORESET0 610 multiplexing pattern with the SSB 605. For example, the SSB 605 includes the MIB which may indicate system information used by a UE to synchronize and connect with the network. The MIB includes information parameters such as system bandwidth, system frame number, and the configuration details of the PBCH of the SSB 605. One of the functions of the MIB is to indicate the configuration of CORESET0 610. By indicating the CORESET0 610 configuration, the MIB ensures that the UE can accurately interpret control signals and effectively manage communication resources. This integration of the MIB within the SSB 605 streamlines the process of network entry, enabling UEs to efficiently acquire information to establish a stable and efficient connection with the network infrastructure.

Additionally, or alternatively, one or more other parameters for the CORESET0 610 may be predefined as part of a wireless communications standard, such as 3GPP. For example, a CCR-to-REG mapping may be predefined. CORESET0 CCE-to-REG mapping may be an aspect of resource allocation, where CCEs are mapped to REGs within the CORESET0 610. This mapping process involves several parameters, including a REG bundle size, an interleaving, and an n_shift. The REG bundle size determines the number of REGs grouped together for mapping purposes, which can impact the granularity and flexibility of resource allocation. “Interleaving” refers to the technique of distributing CCEs across non-consecutive REGs, which helps in minimizing the impact of frequency-selective fading and interference by spreading the control information over a wider frequency range. The n_shift parameter may be used to introduce a shift in the mapping pattern, providing additional diversity and robustness to the control channel by altering the starting point of the CCE-to-REG mapping. Additionally, the CORESET0 610 may be predefined. “CORESET0 610 precoding” may refer to the process of applying a mathematical transformation to the control signals before transmission, optimizing the control signals for the specific characteristics of the wireless channel. This technique enhances signal quality and reduces interference by tailoring the transmission to the spatial properties of the channel, such as multipath propagation and antenna configuration. By employing precoding, CORESET0 610 ensures more reliable and efficient delivery of control information, improving overall network performance and user experience.

As indicated above, FIG. 6 is provided as an example. Other examples may differ from what is described with regard to FIG. 6.

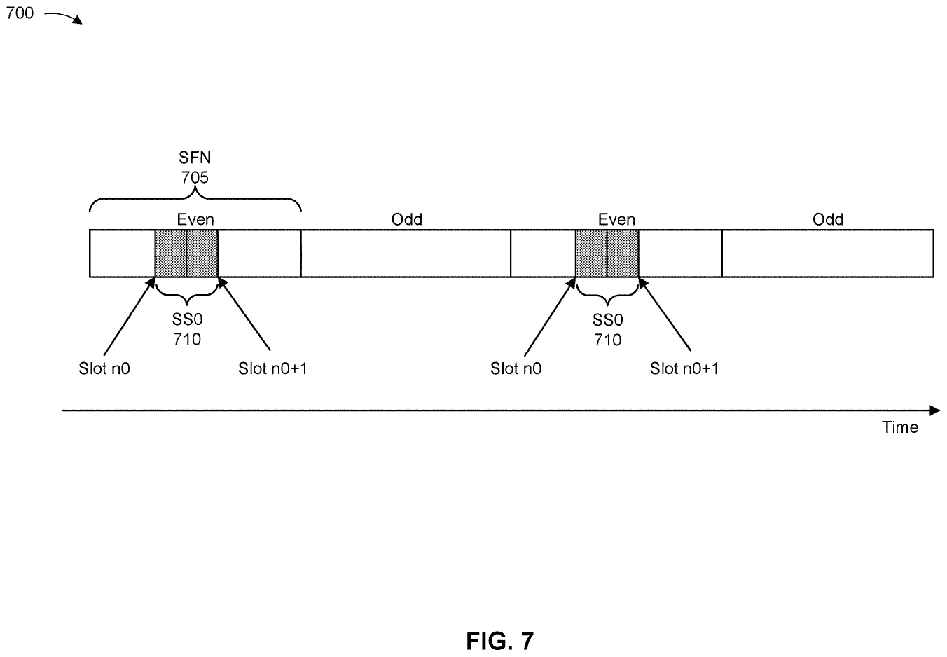

FIG. 7 is a diagram illustrating an example 700 of a search space for a MO.

As described herein, a MIB of an SSB can indicate configuration parameters for the CORESET0. In some examples, the MIB indicates the configuration of a Type0-PDCCH common search space (CSS) set for the CORESET0 that defines the search space of the CORESET0 (e.g., a search space 0 or SS0 710). For example, the Type0-PDCCH CSS set indicates the common search space where control messages can be found, ensuring that the UE can efficiently locate and decode control information for network communication. By providing this configuration, the MIB enables UEs to access control resources effectively and maintain communication with the network infrastructure.

As shown in FIG. 7, the SS0 710 is repeated across multiple system frame numbers (SFNs) (e.g., multiple SFNs 705). The SFN 705 is a parameter used in wireless communication systems to identify the specific frame within a sequence of transmission frames. That is, the SFN 705 serves as a timing reference that helps synchronize the transmission and reception of data between the network and UE. The SFN is used for maintaining the timing alignment necessary for various network operations, such as scheduling, handovers, and ensuring that data packets are correctly ordered and processed. By providing a consistent frame numbering system, the SFN aids in the efficient management and coordination of network resources.

As shown in FIG. 7, the SS0 710 spans a slot no and a slot n0+1 per repetition. In wireless communication systems, SS0 710 plays a role in defining MOs for SSBs and CORESET0 configurations. SS0 710 may be characterized by an association with a slot index n0, which can occur in either odd or even SFNs 705 for the corresponding SSB. As shown in FIG. 7, slot n0 is configured to occur in even SFNs 705. This configuration ensures that the MOs are synchronized with the transmission pattern of the SSB. Specifically, two consecutive slots starting from slot n0 to slot n0+1 are designated for Type0-PDCCH MOs, which are part of the SSB and CORESET0 multiplexing pattern (e.g., multiplexing pattern 1). This arrangement facilitates efficient control signaling and resource allocation by ensuring that the UE can accurately monitor and decode control information. In some examples, a starting symbol index for the slot no and slot n0+1 may be configured. For instance, the starting symbol index within these slots enables aligning the monitoring process with the transmitted signals, ensuring timing and synchronization. The periodicity of SS0 710 can be configured to occur every even or odd SFNs, or the SS0 710 can be set to match the periodicity of the SSB, providing flexibility in adapting to various network conditions. This periodicity ensures that the UE remains in sync with the network transmission schedule, optimizing communication efficiency and reliability.

In the context of the SS0 710 within wireless communication systems, CCE aggregation levels (ALs) play a role in determining the configuration of PDCCH candidates. The ALs (such as AL={4, 8, 16}, among other examples) specify the number of CCEs used to transmit a PDCCH. Each aggregation level corresponds to a different number of PDCCH candidates, which are used to ensure robust and efficient control signaling. The Type0-PDCCH CSS set may be defined by these CCE ALs and the number of PDCCH candidates per aggregation level, as outlined in Table 1:

TABLE 1

| CCE Aggregation Level | Number of PDCCH Candidates |
|---|---|
| 4 | 4 |
| 8 | 2 |
| 16 | 1 |

In some examples, Table 1 may be defined in a wireless communication standard, such a 3GPP. Additionally, Table 1 provides a structured framework for allocating PDCCH resources, ensuring that the UE can effectively monitor and decode control information across varying network conditions. In other words, Table 1 provides specifications for CCE ALs and the maximum number of PDCCH candidates per AL within CSS sets (e.g., configured by an information element (IE) searchSpaceSIBI indicated in RRC signaling). Accordingly, Table 1 serves as a reference for understanding how resources are allocated for control signaling, ensuring that the UE can efficiently monitor and decode PDCCH transmissions across different ALs. By defining these parameters, the table facilitates optimized control channel performance tailored to the network operational requirements. By adjusting the ALs and candidate numbers, the network can optimize the balance between control channel robustness and resource efficiency, catering to diverse communication scenarios and device capabilities.

As indicated above, FIG. 7 is provided as an example. Other examples may differ from what is described with regard to FIG. 7.

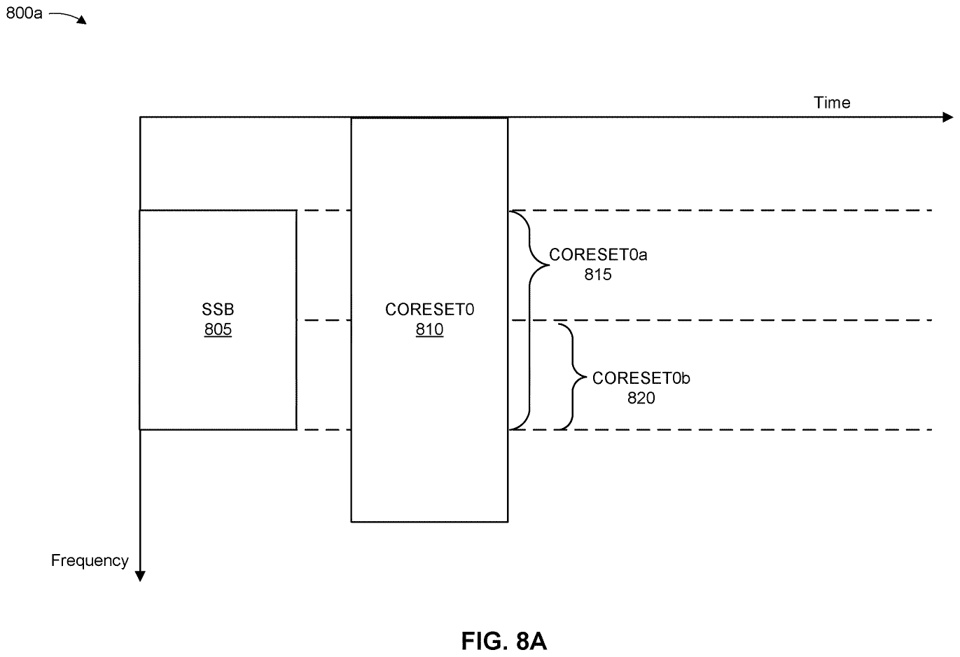

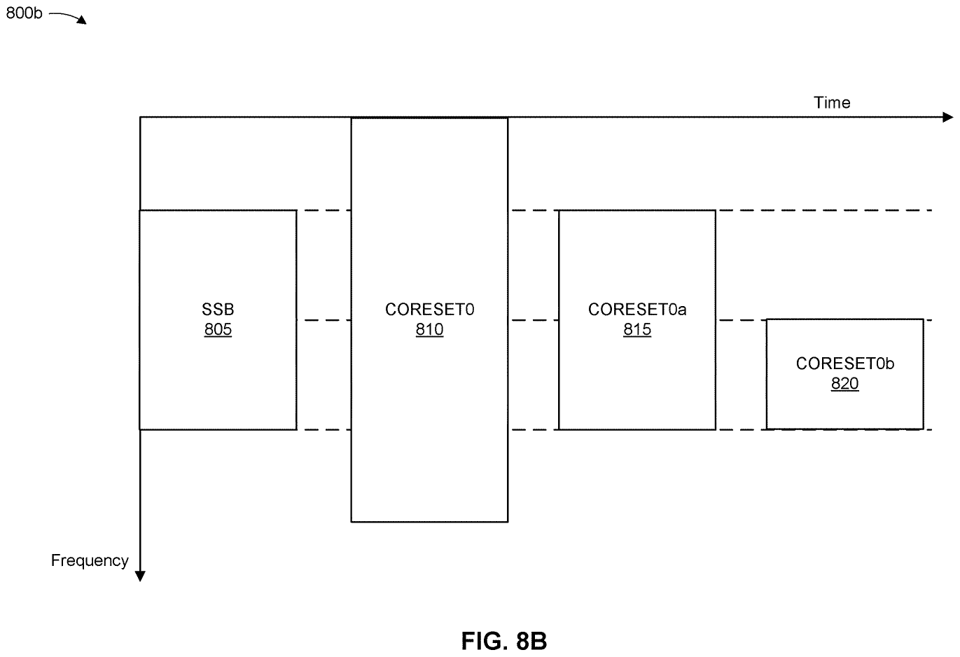

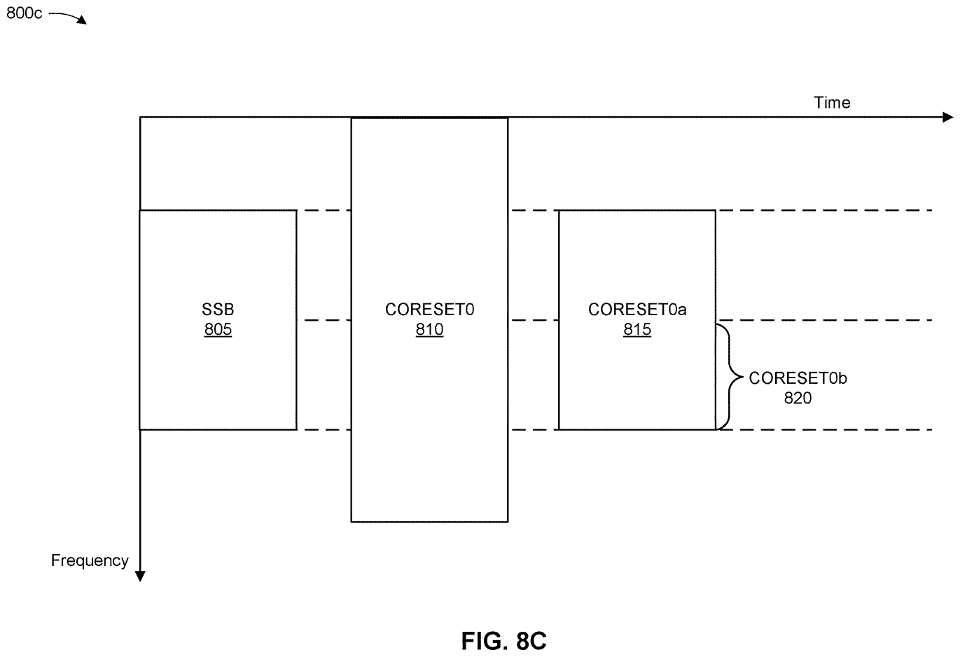

FIGS. 8A through 8C are diagrams illustrating examples 800a, 800b, and 800c associated with different CORESET and search space configurations used by different types of wireless devices. Examples 800a, 800b, and 800c may implement or be implemented by one or more aspects of wireless communication network 100 and examples 200 through 700. For example, the SSB 805 may be an example of one or more SSBs provided herein.

As described herein, different types of wireless devices may be capable of communicating across different sizes of frequency bandwidths. For example, an eMBB device-0, designed for enhanced mobile broadband applications, may support a bandwidth capability of 5 MHz or greater, enabling the eMBB device-0 to handle high data throughput and support demanding applications such as streaming and large file transfers. In contrast, an IoT device-1 may be configured for IoT applications with a maximum bandwidth of 3 MHz, balancing connectivity needs with power efficiency for moderate data transmission tasks. Additionally, an IoT device-2 may be tailored for low-bandwidth IoT applications, with a maximum bandwidth of 1.4 MHz, making the IoT device-2 ideal for scenarios where minimal data is exchanged (such as simple sensor readings or status updates) while prioritizing low power consumption and extended battery life. In other words, the eMBB device-0 may have a first bandwidth capability, the IoT device-1 may have a second bandwidth capability, and the IoT device-2 may have a third bandwidth capability, where the first bandwidth capability is greater than the second bandwidth capability and the second bandwidth capability is greater than the third bandwidth capability. Additionally, the bandwidth capabilities of 5 MHz, 3 MHz, and 1.4 MHz are respective examples for the first bandwidth capability, the second bandwidth capability, and the third bandwidth capability. Accordingly, in other examples, the first bandwidth capability, the second bandwidth capability, and the third bandwidth capability may be different bandwidth capability values. Additionally, each of eMBB device-0, IoT device-1, and IoT device-2 may be referred to herein as a UE.

In accordance with the techniques described herein, the network node 110 may transmit, and one or more UEs of varying bandwidth capability may receive, system information that indicates a plurality of CORESET configurations and one or more search space configurations that are both used for a plurality of device types (e.g., for eMBB device-0, IoT device-1, and IoT device-2). For example, the network node may transmit the SSB 805 that indicates the plurality of CORESET configurations and one or more search space configurations.

As shown in FIG. 8A, and according to the example 800a, the CORESET0 MOs are common for the plurality of device types (e.g., for eMBB device-0, IoT device-1, and IoT device-2). That is, the SSB 805 indicates a CORESET0 810, a CORESET0a 815, and a CORESET0b 815, where the SS0 associated with CORESET0/0a/0b is common for all devices, such that the plurality of CORESET configurations have a same search space that includes a same time location (symbol/slot/SFN index) and periodicity. In wireless communication systems, different device types are configured to monitor various CORESETs based on bandwidth capabilities, ensuring efficient resource utilization and optimal performance. For example, eMBB device-0 (with a channel bandwidth of 5 MHz or greater) is capable of monitoring the CORESET0 810, which can encompass the highest number of PRBs across the plurality of CORESET configurations (such as 24, 48, or 96 PRBs). This allows eMBB device-0 to handle a wide range of control information, suitable for high-demand applications. On the other hand, IoT device-1 (with a channel bandwidth of 3 MHz) is designed to monitor CORESET0a 815. In example 800a, the CORESET0a 815 may be a subset of CORESET0 810 (e.g., comprising 12 or 15 PRBs). This CORESET0a 815 configuration may be tailored to balance resource allocation with the moderate bandwidth capacity of the IoT device-1, ideal for IoT applications requiring efficient control signaling. Meanwhile, IoT device-2 (with a channel bandwidth of 1.4 MHz) focuses on monitoring CORESET0b 820. In example 800a, the CORESET0b 820 may be an even smaller subset of CORESET0 810 (e.g., including around PRBs). The setup of CORESET0b 820 is optimized for reduced data exchange, aligning with the low-bandwidth and low-power requirements of specific IoT scenarios. By tailoring CORESET monitoring to the capabilities of each device type, the network can ensure effective communication while maintaining resource efficiency.

As shown in FIG. 8B, and according to the example 800b, the CORESET0 MOs are separate for the plurality of device types (e.g., for eMBB device-0, IoT device-1, and IoT device-2). That is, the SSB 805 indicates that the CORESET0 810, the CORESET0a 815, and the CORESET0b 815 that are transmitted in a TDM manner (e.g., CORESET0 810 is transmitted according to a search space 0 or SS0, the CORESET0a 815 is transmitted according to a search space 0a or SS0a, and the CORESET0b 820 is transmitted according to a search space 0b or SS0b). For example, as shown in FIG. 8B, the CORESET0 810 may be occur during first time resources defined by SS0, the CORESET0a 815 may occur during second time resources defined by SS0a, and the CORESET0b 820 may occur during third time resources defined by SS0b. By separating the different CORESET configurations across different search space timings, devices of the same bandwidth capability may be aligned in time. Additionally, the different search space configurations may be included in different periodicities and durations, enabling the network node to tailor different CORESET MOs to the different bandwidth capabilities.

As shown in FIG. 8C, and according to the example 800c, the CORESET0 MOs are separate for different subsets of devices for the plurality of device types (e.g., for eMBB device-0, IoT device-1, and IoT device-2). That is, the SSB 805 indicates the CORESET0 810, the CORESET0a 815, and the CORESET0b 815 that are transmitted in a TDM manner (e.g., CORESET0 810 is transmitted according to a search space 0 or SS0, and CORESET0a 815 and the CORESET0b are transmitted according to a search space 0a/b or SS0a/b). For example, as shown in FIG. 8C, the CORESET0 810 may occur during first time resources defined by SS0, and the CORESET0a 815 and CORESET0b 820 may occur during second time resources defined by SS0a/b. Additionally, according to example 800c, the CORESET0b 820 is a subset of the CORESET0a 815. That is, the CORESET0b 820 and the CORESET0a 815 share the same CORESET MO. By separating the different CORESET configurations across different search space timings, devices of the same bandwidth capability may be aligned in time. Additionally, the search space configuration of example 800c enables the network node to separate the CORESET MOs based on a use type of wireless devices (e.g., eMBB devices monitor at a first time and IoT devices monitor at a second time).

Additionally, with reference to examples 800a, 800b, and 800c, in scenarios where different devices monitor CORESET0 810, CORESET0a 815, or CORESET0b 820, a UE may not be provided with dedicated higher layer parameters for configuring its operations. In such cases, the UE can make one or more assumptions to ensure effective monitoring of the PDCCH. Specifically, if the UE is tasked with monitoring PDCCHs for DCI format 1_0, which includes cyclic redundancy check (CRC) scrambled by system information radio network temporary identifier (RNTI), paging-RNTI (P-RNTI), or random access-RNTI (RA-RNTI), then the UE may assume that the ratio of PDCCH demodulation reference signal (DMRS) energy per resource element (EPRE) to SSB EPRE falls within a predefined range, (such as −8 dB to 8 dB). This assumption helps the UE in estimating the power levels of the control signals relative to the synchronization signals, thereby facilitating accurate demodulation and decoding of the control information. By operating within this defined power ratio range, the UE can effectively manage its reception capabilities, ensuring reliable communication even in the absence of specific higher layer configurations. This approach allows the network to maintain robust control signaling across various device types and CORESET configurations, optimizing the UE ability to interpret essential control messages under diverse operational conditions.

When a TCI state is quasi-co-located with the SSB 805, the TCI indicates that the spatial properties, such as angle of arrival or departure, are aligned between the SSB 805 and the associated data or control channels. This alignment allows the network to optimize beamforming and spatial resource management, ensuring consistent propagation conditions and improving signal quality for the UE. The QCL relationship facilitates efficient beam switching and tracking, enhancing communication reliability and reducing the need for additional spatial measurements.

As indicated above, FIGS. 8A through 8C are provided as an example. Other examples may differ from what is described with regard to FIGS. 8A through 8C.

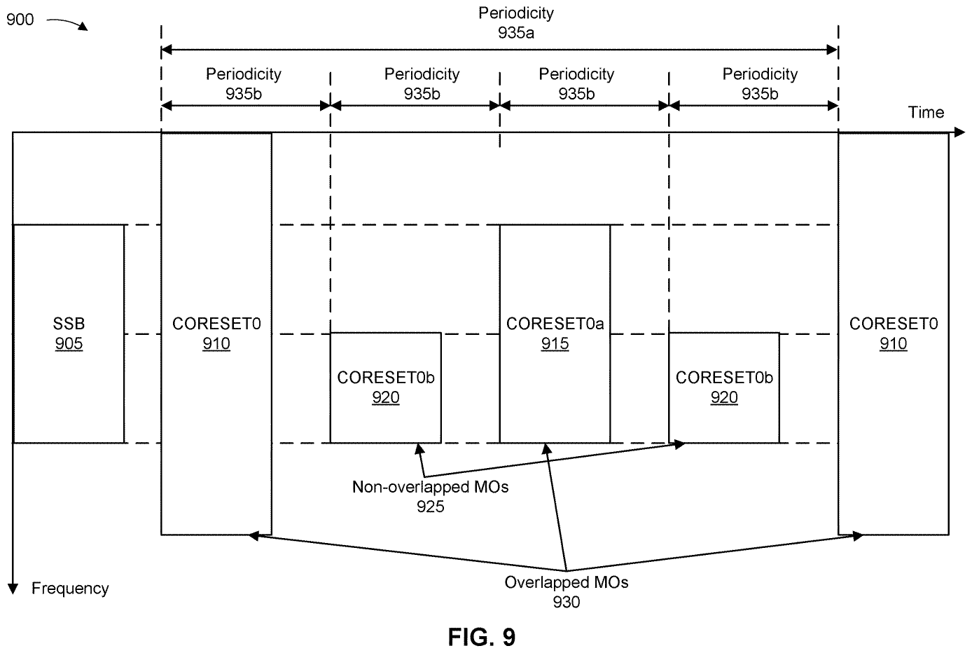

FIG. 9 is a diagram illustrating an example 900 associated with different CORESET and search space configurations used by different types of wireless devices. Example 900 may implement or be implemented by one or more aspects of wireless communication network 100 and examples 200 through 700, and examples 800a through 800c. For example, the SSB 905 may be an example of one or more SSBs provided herein. Additionally, the CORESET0 910, the CORESET0a 915, and the CORESET0b 920 may be respective examples of the CORESET0 810, the CORESET0a 815, and the CORESET0b 820.

In accordance with example 900, the CORESET MOs can be configured to be either common or separate, depending on the operational requirements and device capabilities. This flexibility allows the network to tailor resource allocation and control signaling to suit different device types and their respective bandwidth capabilities. For CORESET0a 915 and CORESET0b 920, the MOs can have either overlapped or non-overlapped SS0 time locations (e.g., SS0a and SS0b may either be the same or separate). This configuration can be achieved by varying the SS0 periodicity or by maintaining the same SS0 periodicity but altering the number of repetitions, thereby providing adaptability in how control resources are managed across different devices.

As shown in FIG. 9, the SSB 905 indicates multiple non-overlapped MOs 925. For examples, the non-overlapped MOs 925 that are configured for a specific device type (e.g., the CORESET0b 920 are configured exclusively for monitoring by UEs that are IoT device-2). In scenarios where MOs are non-overlapped, devices can utilize distinct configurations for CORESET0 910, CORESET0a 915, and CORESET0b 920. This approach allows each device type to optimize control channel monitoring based on its specific bandwidth and processing capabilities, ensuring efficient use of network resources without interference from other device types.

Additionally, as shown in FIG. 9, the SSB 905 indicates multiple overlapped MOs 930, which are CORESET MOs that can be monitored by multiple types of devices (e.g., by more than one of eMBB device-0, IoT device-1, and IoT device-2). For example, each of eMBB device-0, IoT device-1, and IoT device-2 may monitor different portions of the CORESET0 910. Additionally, or alternatively, the IoT device-1 and IoT device-2 can monitor different portions of the CORESET0a 915. In the overlapped MOs, there may be multiple options for configuration management. In a first option, different devices may follow different configurations for CORESET0 910, CORESET0a 915, and CORESET0b 920 (e.g., described with reference to example 800b). This first option maintains the individualized approach to resource allocation, ensuring that each device type can operate optimally according to separate configuration parameters. A second option, however, introduces a common configuration for CORESET0 910, CORESET0a 915, and CORESET0b 920 across all devices (e.g., described with reference to example 800a). The unified approach of the second option can simplify network management and potentially reduce signaling overhead, as all devices adhere to a single set of configuration parameters during overlapped MOs. Accordingly, the second option is particularly useful in scenarios where uniformity across devices is beneficial, such as in environments with consistent network conditions or when deploying large-scale IoT solutions.

Accordingly, the SSB 905 may indicate different periodicities 935 to indicate the structure and repetition of the non-overlapped MOs 925 and the overlapped MOs 930. For example, periodicity 935a indicates the time period corresponding to a CORESET MO pattern that includes multiple non-overlapped MOs 925 and multiple overlapped MOs 930. Additionally, periodicity 935b indicates the time period between each CORESET MO that is included within the CORESET MO pattern.

As indicated above, FIG. 9 is provided as an example. Other examples may differ from what is described with regard to FIG. 9.

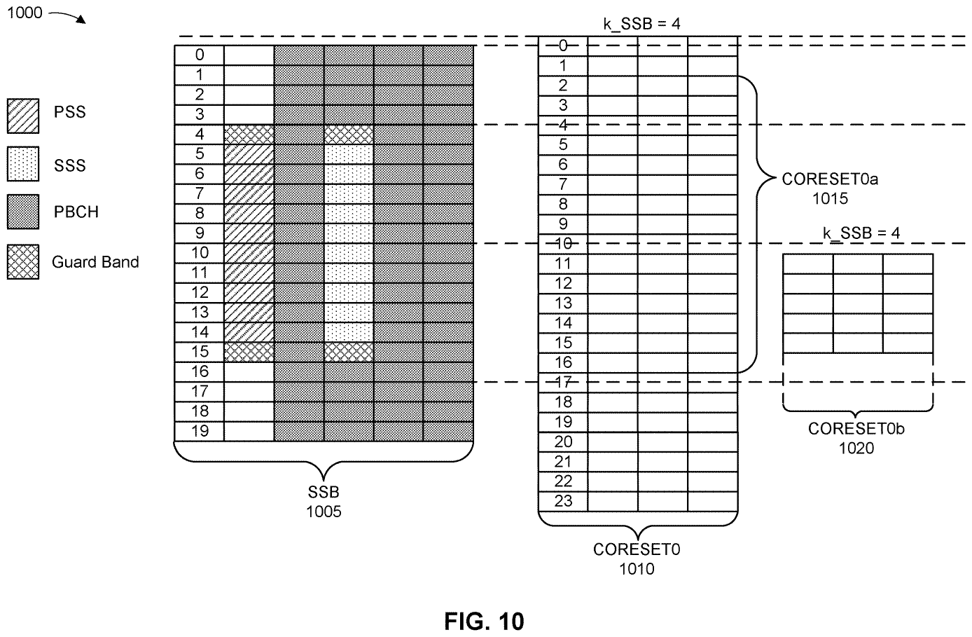

FIG. 10 is a diagram illustrating an example 1000 associated with RB boundary alignment for different CORESET configurations used by different types of wireless devices. Example 1000 may implement or be implemented by one or more aspects of wireless communication network 100 and example 200 through 900. For example, the SSB 1005 may be an example of one or more SSBs provided herein. Additionally, the CORESET0 1010, the CORESET0a 1015, and the CORESET0b 1020 may be respective examples of the CORESET0 810, the CORESET0a 815, and the CORESET0b 820.

In the context of CORESET0 1010, CORESET0a 1015, and CORESET0b 1020, RB boundary alignment with a common resource block (CRB) enables efficient resource allocation and signal processing. With reference to example 1000, achieving the RB alignment involves aligning the RB boundaries of the CORESETs with a CRB by indicating a common k_SSB relative to the SSB 1005 (e.g., a common subcarrier offset 625 for each of the CORESET configurations). For instance, in example 1000, the k_SSB value for each of CORESET0 1010, CORESET0a 1015, and CORESET0b 1020 is equal to 4 (e.g., k_SSB=4). This ensures that each CORESET RB boundary is synchronized with the CRB RB boundary, facilitating seamless integration and coordination within the network resource grid.

When the SCS for the CORESET0 1010, CORESET0a 1015, and CORESET0b 1020 is the same as that of the CRB, the RB boundaries of each CORESET align with all RB boundaries of the CRB. This alignment ensures that the CORESETs can fully utilize the available RBs for CCE mapping. However, if the SCS differs between the CORESETs and the CRB, the alignment may occur with a subset of the CRB RB boundaries. In some examples, the CRB may assume an SCS for the CORESETs to be 15 kHz, which serves as a standard reference for alignment.

In some examples, partial RBs within the reduced bandwidth of CORESET0a 1015 and CORESET0b 1020 may not be used for CCE mapping. For instance, in example 1000, the CORESET0b 1020 may span RBs 10 through 15 (e.g., 6 PRBs); however, RB 10 may not be used for CCE mapping because the k_SSB partially overlaps with the subcarriers of RB 10. Accordingly, as shown in FIG. 10, the RB 10 is not used for CCE mapping for the CORESET0b 1020. In some examples, a k_SSB value may be valid for a device type but not valid for another device type. For instance, if k_SSB=0, the CORESET0b 1020 in FIG. 10 can have 6RBs for CCE mapping; otherwise, the CORESET0b 1020 may have less than 6RBs (smaller than the minimum CORESET size), which may not be used to transmit a PDCCH for IoT device-2. Accordingly, whether the k_SSB indicated by MIB or PBCH (in the SSB 1005) is valid or not can implicitly indicate whether the network can support the device type or not.

As indicated above, FIG. 10 is provided as an example. Other examples may differ from what is described with regard to FIG. 10.

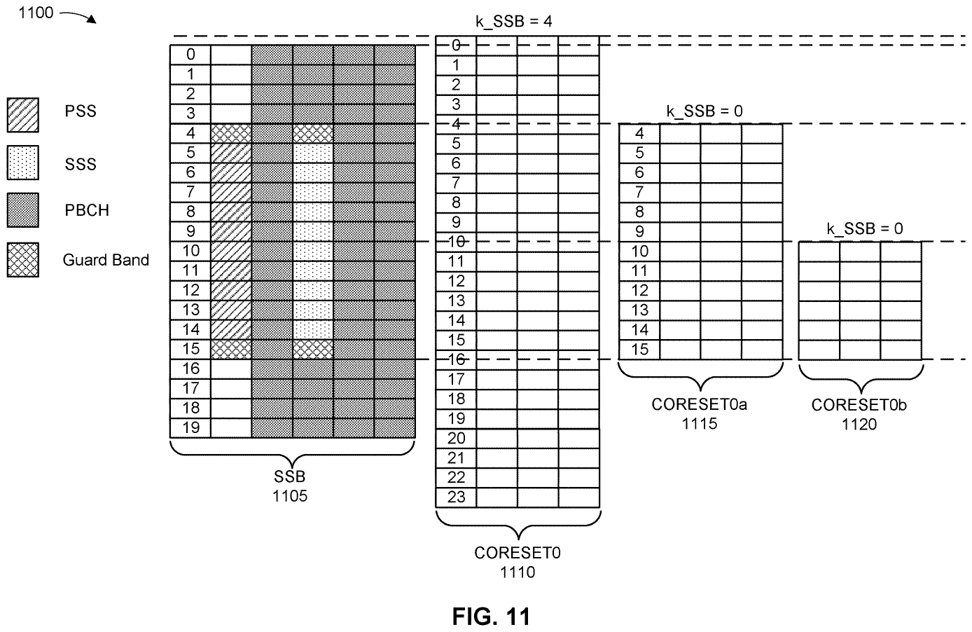

FIG. 11 is a diagram illustrating an example 1100 associated with RB boundary alignment for different CORESET configurations used by different types of wireless devices. Example 1100 may implement or be implemented by one or more aspects of wireless communication network 100 and examples 200 through 1000. For example, the SSB 1105 may be an example of one or more SSBs provided herein. Additionally, the CORESET0 1110, the CORESET0a 1115, and the CORESET0b 1120 may be respective examples of the CORESET0 810, the CORESET0a 815, and the CORESET0b 820. In some cases, example 1100 may serve as an alternative to example 1000.

According to example 1100, boundary alignment for CORESET0 1110, CORESET0a 1115, and CORESET0b 1120 involves not aligning these CORESETs with the CRB by indicating different k_SSB values relative to the SSB 1105. For instance, example 1110 introduces flexibility in the configuration of CORESETs by allowing CORESET0a 1115 and CORESET0b 11120 to have distinct k_SSB values or additional subcarrier offsets compared to CORESET0 1110. As shown in FIG. 11, the k_SSB for CORESET0 1110 is 4, the k_SSB for CORESET0a 1115 is 0, and the k_SSB for CORESET0b 1120 is 0. This differentiation in alignment can be beneficial in scenarios where varying network conditions or device capabilities necessitate tailored resource allocation strategies.

By not aligning CORESET0a and CORESET0b with the CRB boundary, the network can implement unique configurations for the CORESET0 1110, the CORESET0a 1115, and the CORESET0b 1120, potentially optimizing performance for specific use cases or device types.

As indicated above, FIG. 11 is provided as an example. Other examples may differ from what is described with regard to FIG. 11.

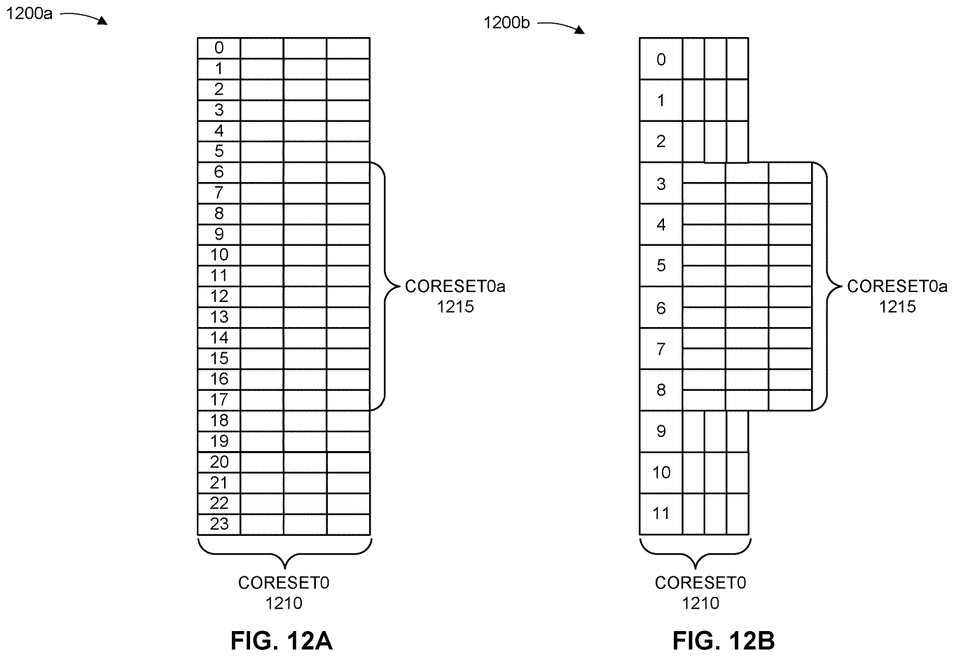

FIGS. 12A and 12B are diagrams illustrating examples 1200a and 1200b associated with SCS for different CORESET configurations used by different types of wireless devices. Examples 1200a and 1200b may implement or be implemented by one or more aspects of wireless communication network 100 and examples 200 through 1100. For instance, the CORESET0 1210 and CORESET0a 1215 may be respective examples of the CORESET0 810 and the CORESET0a 815.

The SCS configuration for CORESET0, CORESET0a, and CORESET0b enables resource management in wireless networks, impacting how control information is transmitted and received. The network may implement one or more options for configuring the SCS across these CORESETs, each offering distinct advantages depending on the network operational goals and device capabilities.

FIG. 12A illustrates an SCS configuration according to a first option. The first option involves using the same SCS for CORESET0 1210 and CORESET0a 1215 (such as 15 kHz). This uniformity ensures that the RB and symbol boundaries are consistent across these CORESETs, simplifying the mapping and alignment processes. By maintaining the same SCS, the network can streamline resource allocation and reduce complexity, as the control channels can be managed using a unified framework. The first option may be beneficial in scenarios where devices have similar bandwidth capabilities or where the network prioritizes ease of configuration and maintenance.

FIG. 12B illustrates an SCS configuration according to a second option. The second option allows for different SCS configurations (such as 30 kHz for CORESET0 1210 and 15 kHz for CORESET0a 1215). This differentiation in SCS provides flexibility in tailoring the CORESETs to specific communication characteristics or device types. For instance, a higher SCS like 30 kHz for CORESET0 1210 can support faster data rates and lower latency, making the CORESET0 1210 suitable for high-performance applications or devices with greater bandwidth capabilities. Conversely, a lower SCS like 15 kHz for CORESET0a 1215 can cater to devices optimized for resource usage and power efficiency.

Additionally, the techniques of examples 1200a and 1200b may additionally be implemented for the CORESET0b provided elsewhere herein. For example, the CORESET0b may have the same SCS configuration as the CORESET0a 1215.

As indicated above, FIGS. 12A and 12B are provided as an example. Other examples may differ from what is described with regard to FIGS. 12A and 12B.

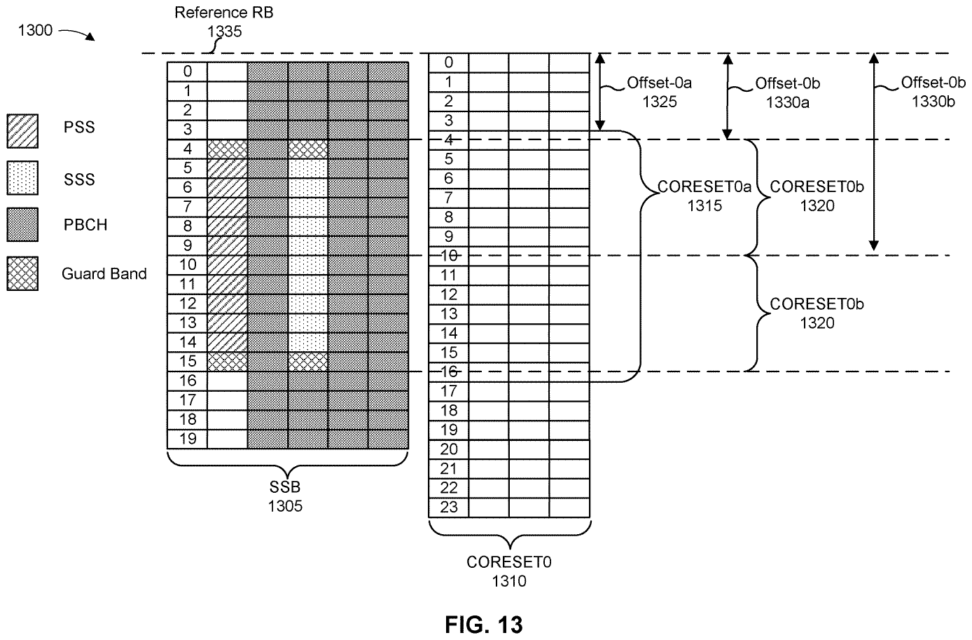

FIG. 13 is a diagram illustrating an example 1300 associated with an RB offset for different CORESET configurations used by different types of wireless devices. Example 1300 may implement or be implemented by one or more aspects of wireless communication network 100, examples 200 through 1100, and examples 1200a and 1200b. For example, the SSB 1305 may be an example of one or more SSBs provided herein. Additionally, the CORESET0 1310, CORESET0a 1315, and the CORESET0b 1320 may be respective examples of the CORESET0 810, CORESET0a 815, and the CORESET0b 820.

The configuration of the RB offset for CORESET0 1310, CORESET0a 1315, and CORESET0b 1320 may be used for aligning these different CORESETs with the broader network resource grid. This RB offset can be configured either through the MIB (e.g., indicated vie the MIB of the SSB 1305) or predefined relative to a reference RB 1335 as part of a wireless communications standard, such as 3GPP. The reference RB 1335 serves as a pivotal anchor point, ensuring that the CORESETs are accurately positioned within the network frequency domain.

The reference RB 1335 can be selected from various elements within the network, such as an RB within the SSB 1305, a CRB, or CORESET0 1315. For instance, the reference RB 1335 may be the center, lowest, or highest CRB within the CORESET0 1315, or the lowest or highest CRB that overlaps with the center, lowest, or highest RB in a SSB 1305 or a PSS/SS of the SSB 1305. This flexibility in choosing the reference RB 1335 allows the network to tailor the alignment of CORESETs based on specific deployment scenarios and operational requirements.

The reference RBs 1335 for CORESET0 1310, CORESET0a 1315, and CORESET0b 1320 can be the same or different, depending on the desired configuration strategy. Using the same reference RB 1335 across these CORESETs can simplify the alignment process and ensure uniformity in resource allocation. Conversely, selecting different reference RBs 1335 for each CORESET allows for more granular control over their positioning, which can be advantageous in complex network environments with diverse device capabilities and communication needs. The one or more reference RBs 1335 can be configured through the MIB (e.g., indicated via the MIB of the SSB 1305) or predefined as part of a wireless communication standard, such as 3GPP.

As shown in FIG. 13, the reference RB 1335 is positioned at the lowest RB of the CORESET0 1310. Accordingly, the RB offset for the CORESET0 1310 is 0 RBs (e.g., offset-0=0 RBs). Additionally, the RB offset for the CORESET0a 1315 (e.g., an offset-0a 1325) is equal to −4 RBs (e.g., offset-0a=−4 RBs). Additionally, the RB offset for the CORESET0b 1320 (e.g., an offset-0b 1330a or 1330b) is equal to −4 RBs (e.g., offset-0b=−4 RBs) or to −10 RB (e.g., offset-0b=−10 RBs).

Ultimately, the configuration of the RB offsets for the different CORESETs plays a role in optimizing the performance and efficiency of control signaling within the network. By selecting and aligning the reference RBs 1335, network operators can enhance the reliability and effectiveness of CORESET deployments, ensuring that control information is transmitted and received with precision across various device types and use cases.

As indicated above, FIG. 13 is provided as an example. Other examples may differ from what is described with regard to FIG. 13.

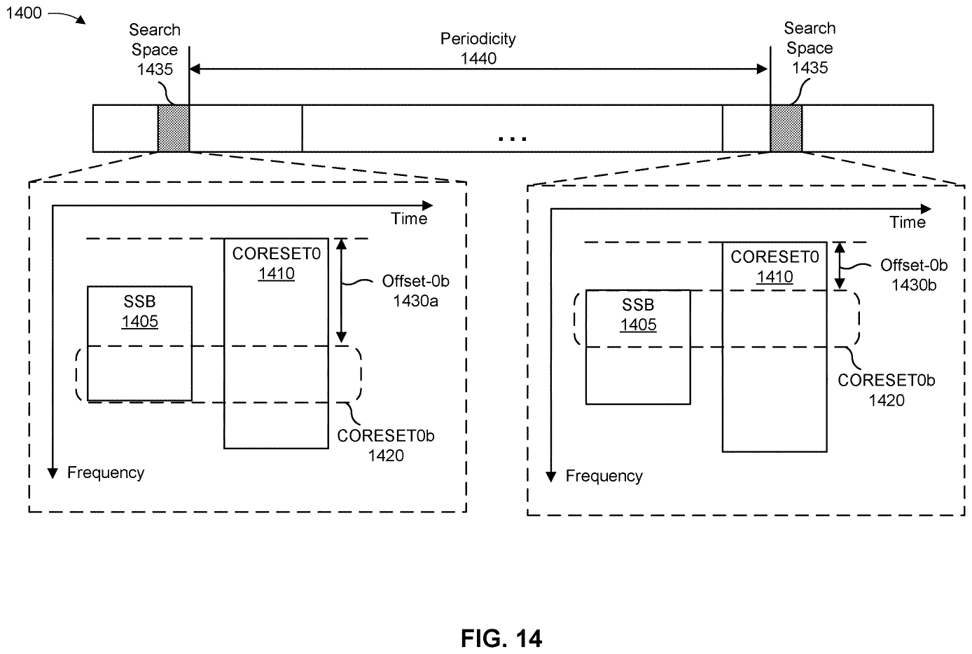

FIG. 14 is a diagram illustrating an example 1400 associated with multiple RB offsets for a CORESET0b. Example 1400 may implement or be implemented by one or more aspects of wireless communication network 100, examples 200 through 1100, and examples 1200a and 1200b. For example, the SSB 1405 may be an example of one or more SSBs provided herein. Additionally, the CORESET0b 1420 may be an example of the CORESET0b 820. Additionally, the offset-0b 1430a and 1430b may be examples of the offset-0b 1330a and 1330b.

The RB offset for CORESET0b 1420 is a configuration that ensures alignment of the CORESET0b 1420 with the network resource grid, particularly in relation to control channel signaling. For CORESET0b 1420, the RB offset can be predefined relative to a reference RB, such as {−10 RBs or −4 RBs} from the lowest RB in CORESET0 1410 that overlaps with the lowest RB in the SSB 1405. This reference RB allows CORESET0b 1420 to be strategically positioned within the frequency domain, facilitating efficient monitoring and decoding of control information by the UE.

The UE can utilize this RB offset configuration to monitor one half of the PSS, SSS, and PBCH part 1, along with CORESET0b 1420, and then retune to the other half of the PSS, SSS, and PBCH part 1 within the same subband. This approach enables the UE to effectively manage bandwidth and processing capabilities, ensuring that the UE can capture and decode synchronization and control signals without interference or overlap.

To further optimize the positioning of CORESET0b 1420, an RB offset changing pattern can be predefined or configured via an MIB of the SSB 1405. This pattern informs the UE of the location of CORESET0b 1420 for the associated PDCCH, allowing for reliable control channel monitoring. The RB offset changing pattern can be based on CORESET0 MOs and periodicity, ensuring that the UE remains synchronized with the network transmission schedule and can adapt to dynamic changes in resource allocation.

The configuration of the RB offset for CORESET0b involves a strategic approach to periodicity and CORESET MOs, aligning with the broader framework of CORESET0 1410. For CORESET0 1410, the periodicity and MOs are determined at slot n0 within the SFN index (e.g., SFNc), with a periodicity 1440 (e.g., CORESET0_periodicity or SS0_periodicity associated with CORESET0). This may be mathematically expressed as (SFNc*10 mod CORESET0_periodicity)=0 when (n0 mod CORESET0_Periodicity)=0, and (SFNc*10 mod CORESET0_periodicity)=1 when (n0 mod CORESET0_periodicity)=1. This configuration ensures that CORESET0 1410 is consistently aligned with the network transmission schedule, facilitating reliable control channel monitoring.

For CORESET0b 1420, the RB offset changing pattern is linked to the periodicity of CORESET0 1410, with the offset-0b 1430 changing pattern periodicity being a multiple (e.g., ratio) of the CORESET0 periodicity. This relationship allows for a dynamic adjustment of the RB offset for CORESET0b, ensuring that the RB offset remains positioned within the network resource grid. Specifically, the offset-0b 1430a (e.g., offset-0b=−10 RBs) is used at SFNc when the condition floor (SFNc*10/CORESET0_periodicity) mod ratio=0 is satisfied. Conversely, the offset-0b 1430b (e.g., offset-0b=−4 RBs) is used at SFNc when the condition floor (SFNc*10/CORESET0_periodicity) mod ratio=1 is met.

As shown in FIG. 14, during the first instance of the search space 1435, the condition floor (SFNc*10/CORESET0_periodicity) mod ratio=0 is satisfied. Therefore, the UE may use offset-0b 1430a to decode the lower half of the SSB 1405 and monitor via the CORESET0b 1420 corresponding to the offset-0b 1430a. As shown in FIG. 14, during the subsequent instance of the search space 1435, the condition floor (SFNc*10/CORESET0_periodicity) mod ratio=1 is satisfied. Therefore, the UE may use the offset-0b 1430b to decode the upper half of the SSB 1405 and monitor via the CORESET0b 1420 corresponding to the offset-0b 1430b.

This flexible offset configuration for CORESET0b enables the network to adapt to varying communication demands and environmental conditions, ensuring that control signaling remains robust and efficient. By leveraging the periodicity and offset patterns, the network can maintain precise alignment of CORESET0b 1420 with the associated physical downlink control channel (PDCCH), optimizing resource utilization and enhancing the overall performance of the network. This approach is particularly beneficial in supporting diverse device types and use cases, allowing for tailored resource allocation that meets the specific needs of each communication scenario. By implementing an RB offset strategy for CORESET0b, network operators can enhance the performance and reliability of control signaling, ensuring that even devices with limited bandwidth (e.g., IoT device-2) can effectively participate in the network communication processes.

As indicated above, FIG. 14 is provided as an example. Other examples may differ from what is described with regard to FIG. 14.

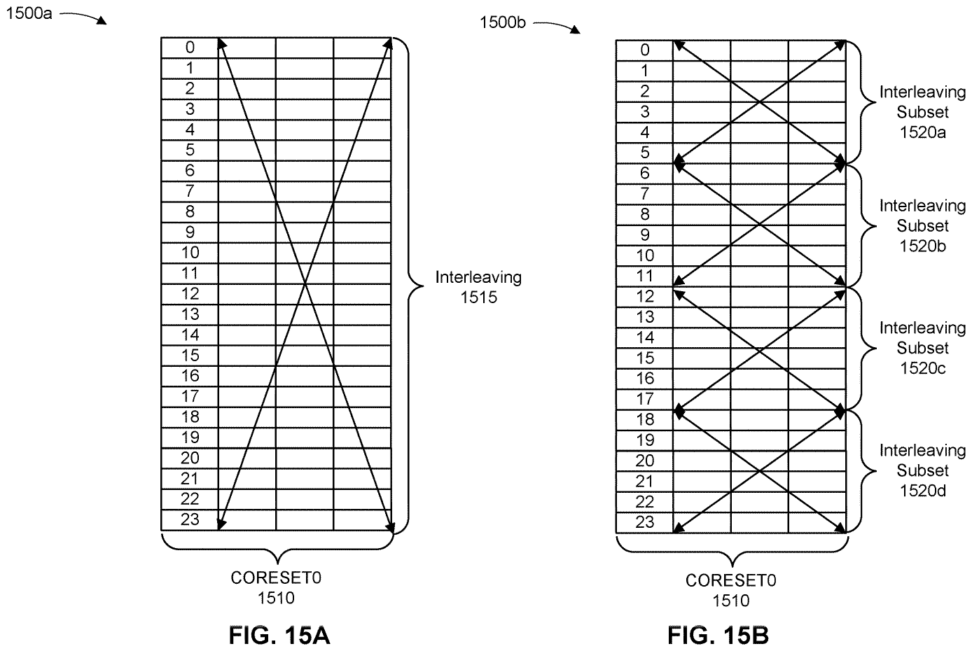

FIGS. 15A and 15B are diagrams illustrating examples 1500a and 1500b associated with CCE-to-REG mapping interleaving patterns for different CORESET configurations. Examples 1500a and 1500b may implement or be implemented by one or more aspects of wireless communication network 100 and examples 200 through 1400. For example, the CORESET0 1510 may be an example of the CORESET0 810.

In the context of the CORESET 1510, the CCE-to-REG mapping interleaving pattern may be a technique used to distribute control information across the frequency domain. This pattern determines how CCEs, which carry the PDCCH information, are mapped onto REGs (e.g., the smallest units of resource allocation within a CORESET). Interleaving involves spreading CCEs across non-consecutive REGs, rather than mapping them to adjacent REGs. This approach helps mitigate the effects of frequency-selective fading and interference by ensuring that control information is distributed over a wider frequency range. As a result, the interleaving pattern enhances the reliability and robustness of control signaling, improving a network ability to maintain stable communication links even in challenging radio environments. By strategically interleaving CCEs across REGs, the network can optimize resource utilization and ensure that control information is effectively transmitted and received, supporting efficient and reliable communication across diverse device types and scenarios.

In some examples, the different CORESET configurations (e.g., CORESET0, CORESET0a, and CORESET0b) may operate according to a non-interleaving pattern for the CCE-to-REG mapping. For instance, “non-interleaving” refers to a CCE-to-REG mapping pattern where consecutive CCEs are directly mapped to adjacent REGs within the CORESET0a or the CORESET0b for a given PDCCH candidate. This means that for ALs greater than 1, the CCEs are placed sequentially, without spreading them across non-consecutive REGs. This straightforward mapping can simplify the decoding process for the UE, as the control information is concentrated within a specific portion of the CORESET, reducing complexity in signal processing.

Alternatively to non-interleaving, examples 1500a and 1500b may provide different interleaving schemes for the CCE-to-REG mapping pattern.

As shown in FIG. 15A, the CORESET0 1510 is configured with interleaving across the full frequency bandwidth of the CORESET0 1510. For instance, example 1500a involves an interleaving pattern where CCEs are distributed across the entire bandwidth of the CORESET0 1510 (e.g., according to interleaving 1515), rather than being confined to consecutive REGs. In this configuration, for ALs greater than 1, the interleaved CCEs may partially fall within the range of CORESET0a or CORESET0b. This partial overlap can lead to segments of CCEs that are unusable within CORESET0a or CORESET0b, as the interleaving spreads the control information beyond the specific boundaries of these subsets.

As shown in FIG. 15B, the CORESET0 1510 is configured with multiple subsets of interleaving patterns. For instance, example 1500b presents an interleaving pattern where the distribution of CCEs is confined to multiple interleaving subsets 1520 within CORESET0 1510, specifically tailored to fit within the boundaries of CORESET0a or CORESET0b. For instance, interleaving subset 1520a enables interleaving across RBs 0 through 5 of CORESET0 1510, interleaving subset 1520b enables interleaving across RBs 6 through 11 of CORESET0 1510, interleaving subset 1520c enables interleaving across RBs 12 through 17 of CORESET0 1510, and interleaving subset 1520d enables interleaving across RBs 18 through 23 of CORESET0 1510.

This approach of interleaving subsets ensures that for ALs greater than 1, the interleaved CCEs remain entirely within the range of CORESET0a or CORESET0b, maximizing the usability of control resources within these subsets. By restricting interleaving to smaller portions of CORESET0 1510, example 1500b balances the benefits of interleaving (such as enhanced robustness against frequency-selective fading) while ensuring that all CCEs are effectively utilized within CORESET0a or CORESET0b. This targeted interleaving strategy optimizes resource allocation and control signaling efficiency, particularly for devices with limited bandwidth capabilities, by ensuring that the interleaved control information is fully accessible and usable within the designated CORESET subsets. In some examples, whether interleaving is used or not and which interleaving pattern is used (if interleaving is applied) can be predefined or configurable.

As indicated above, FIGS. 15A and 15B are provided as an example. Other examples may differ from what is described with regard to FIGS. 15A and 15B.

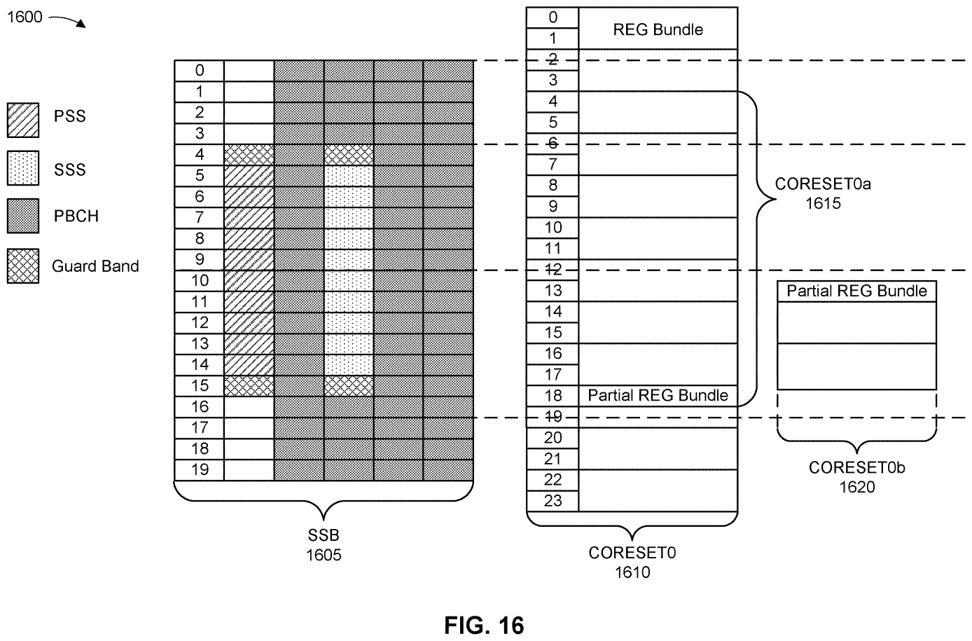

FIG. 16 is a diagram illustrating an example 1600 associated with precoding different CORESETs used by different types of wireless devices. Example 1600 may implement or be implemented by one or more aspects of wireless communication network 100, examples 200 through 1400, and examples 1500a and 1500b. For example, the SSB 1605 may be an example of one or more SSBs provided herein. Additionally, the CORESET0 1610, the CORESET0a 1615, and the CORESET0b 1620 may be respective examples of the CORESET0 810, the CORESET0a 815, and the CORESET0b 820.

In some examples, precoding for a CORESET involves optimizing the transmission of control information to enhance signal quality and reduce interference. For instance, “REG-bundle precoding” refers to a technique where precoding is applied to groups of REGs within a CORESET, allowing for targeted signal processing that can adapt to varying channel conditions. Accordingly, REG-bundle precoding enhances robustness by tailoring the transmission to specific spatial characteristics, such as multipath propagation and antenna configuration. Additionally, or alternatively, wideband precoding may involve applying precoding across the entire bandwidth of the CORESET, enabling consistent signal quality and reliability across a broader frequency range. Wideband precoding may be beneficial in scenarios configured for uniform performance across diverse network conditions, ensuring that control information is effectively transmitted and received by devices with varying capabilities. Both REG-bundle precoding and wideband precoding are integral to optimizing CORESET configurations, facilitating efficient and reliable communication in wireless networks.

In some examples, precoding for CORESET0 1610, CORESET0a 1615, and CORESET0b 1620 may involve the application of REG-bundle precoding. This approach allows for more granular control over the signal spatial properties, enabling flexible beamforming or precoder cycling. For instance, the network node may utilize a REG-bundling precoding for the CORESET0 1610, which facilitates the dynamic adjustment of beamforming parameters to optimize signal quality and coverage. As shown in FIG. 16, the CORESET0 1610 has an REG-bundle size that spans two consecutive RBs and three consecutive symbols. In some examples, the REG-bundle size may be the same as the CCE size. Alternatively, the REG-bundle for precoding may be separately configured (e.g., larger than one CCE in size). REG-bundle precoding may be advantageous in environments with varying channel conditions, allowing the network to adaptively manage the transmission characteristics to maintain robust communication links.

As shown in FIG. 16, the CORESET0a 1615 and the CORESET0b 1620 include a partial REG bundle. “Partial REG-bundle” refers to a situation where a subset of the REGs within a predefined REG-bundle is utilized for transmission. This can occur when the REG-bundle size does not align with the available frequency resources or when specific transmission requirements necessitate the use of part of the bundle. Partial REG-bundles may be used to accommodate devices with limited bandwidth capabilities, such as those operating in CORESET0a 1610 or CORESET0b 1620 configurations, where the full REG-bundle cannot be supported due to reductions in bandwidth or based on the subcarrier offset. As shown in FIG. 16, the CORESET0a 1610 includes a partial REG bundle that spans a single RB (e.g., RB 18) and three consecutive symbols. Additionally, the CORESET0b 1620 includes a partial REG bundle that spans a single RB (e.g., RB 13) and three consecutive symbols. By using partial REG-bundles, the network can optimize resource allocation and ensure that control information is transmitted efficiently, even when full REG-bundle utilization is not feasible.

Additionally, or alternatively, the network node may apply wideband precoding to the CORESET0 1610, CORESET0a 1615, and CORESET0b 1620. Wideband precoding for CORESET0 1610, CORESET0a 1615, and CORESET0b 1620 involves the network node applying a uniform precoding strategy across the entire bandwidth of the CORESETs, rather than focusing on specific REG-bundles. This approach ensures that all RBs within the range of CORESET0a 1615 and CORESET0b 1620 are subject to the same precoding parameters, facilitating consistent signal quality and reliability across the entire frequency range. One of the key advantages of wideband precoding is the ability to enable channel estimation for all RBs within the CORESET0a 1615 and CORESET0b 1620 configurations. By providing a uniform precoding scheme, wideband precoding allows UEs to effectively estimate the channel characteristics across all RBs, enhancing the accuracy and robustness of the communication link. This is particularly beneficial for devices with varying bandwidth capabilities, as wideband precoding ensures that devices with limited resource reception capabilities can achieve reliable channel estimation and maintain effective communication. Wideband precoding thus optimizes CORESET configurations, supporting efficient and reliable transmission of control information in diverse network environments. In some examples, which precoding scheme that is used or which REG-bundle size for precoding that is used can be predefined or configurable.

In some examples, the network node may configure CORESET0a 1615 and CORESET0b 1620 with a longer duration than CORESET0 1610, such that CORESET0a 1615 and CORESET0b 1620 utilize more symbols for transmission. For instance, in one example, CORESET0 1610 may be configured to use 2 or 3 symbols, which is sufficient for control signaling for an eMBB device-0. However, in one example, CORESET0a 1615 and CORESET0b 1620 may be configured to use more than 3 symbols (or some other number of symbols), providing extended time resources for transmitting control information. The CORESET0a may be configured to be associated with a search space set using intra-slot and/or inter-slot repetitions, and DMRS bundling to improve the PDCCH coverage. This increased duration can enhance coverage such as at the cell edge or in environments with high interference. By allocating additional symbols, CORESET0a 1615 and CORESET0b 1620 can improve the reliability and robustness of control signaling, ensuring that a UE can maintain stable connections. The longer duration allows for more comprehensive channel estimation and better signal processing, supporting improved network performance and user experience in areas where coverage may otherwise be limited.

Additionally, or alternatively, the network node may perform CCE/REG-bundle mapping for the CORESET0 1610, CORESET0a 1615, and CORESET0b 1620. For example, the CCE/REG-bundle mapping may be part of configuring CORESETs in wireless communication, as CCE/REG-bundle mapping determines how CCEs are mapped to REGs within a CORESET. This mapping enables organizing the transmission of control information, such as scheduling and resource allocation, to UEs. In the context of the CORESET0 1610, CORESET0a 1615, and CORESET0b 1620, the network node may perform CCE/REG-bundle mapping according to one or more techniques.

A first CCE/REG-bundle technique involves using the same CCE/REG-bundle unit across CORESET0 1610, CORESET0a 1615, and CORESET0b 1620. In this first technique, a CCE may comprise 6 REGs, with an REG bundle size of L=6. This uniformity ensures that the CCE/REG-bundle mapping for CORESET0a 1615 and CORESET0b 1620 is consistent with that of CORESET0 1610, simplifying the network control signaling structure. In some examples, the first technique may result in partial CCEs within CORESET0a 1615 and CORESET0b 1620, such as if these CORESETs have different bandwidth capabilities or symbol durations compared to the CORESET0 1610.

A second CCE/REG-bundle technique enables different CCE/REG-bundle units for CORESET0 1610, CORESET0a 1615, and CORESET0b 1620 (e.g., via an indication in the MIB of the SSB 1605). This second technique allows for a more tailored CCE/REG mapping that can better accommodate the specific characteristics of each CORESET. For instance, in one example, CORESET0 1610 may maintain an REG bundle size of L=6 (e.g., corresponding to 2 RBs across 3 symbols). In contrast, CORESET0a 1615 and CORESET0b 1620 may use a different mapping, such as L=6, with 1 RB spanning 6 consecutive symbols configured for these CORESETs. This flexibility in different CCE/REG-bundle mappings for different CORESETs enables the network to optimize control signaling for different device types and coverage requirements, ensuring efficient resource utilization and robust communication even in diverse and challenging environments. By allowing for differentiated CCE/REG-bundle mapping, the second technique can enhance the adaptability and performance of the network, particularly for UEs with varying capabilities and in areas requiring enhanced coverage.

As indicated above, FIG. 16 is provided as an example. Other examples may differ from what is described with regard to FIG. 16.

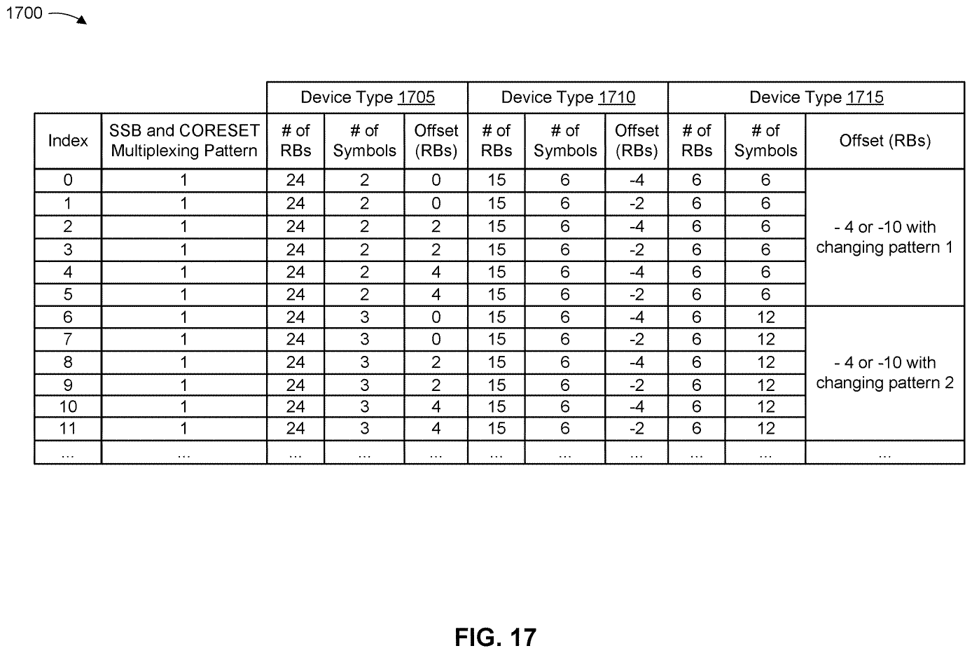

FIG. 17 is a diagram illustrating an example 1700 associated with different entries of an MIB indication to jointly indicate different CORESET configurations. Example 1700 may implement or be implemented by one or more aspects of wireless communication network 100 and examples 200 through 1600.

As shown in FIG. 17, example 1700 includes a table where a set of indexes (e.g., index 0 through 11) indicate different parameters for configuring different CORESETs (e.g., CORESET0, CORESET0a, and CORESET0b). In some cases, the table of example 1700 may be defined as part of a wireless communication standard, such as 3GPP. Additionally, the table may be preconfigured and stored at the memory of various UEs (e.g., as part of an original manufacturer equipment (OEM) configuration).

In accordance with being preconfigured with the table of example 1700, different devices of different device types can determine parameters to use for monitoring a CORESET. As shown in FIG. 17, different entries may be based on the device type of the wireless device monitoring for the CORESET. For example, device type 1705 may be an example of the eMBB device-0 (e.g., a device with a bandwidth greater than or equal to 5 MHz), device type 1710 may be an example of the IoT device-1 (e.g., a device with a bandwidth of 3 MHz), and a device type 1715 may be an example of the IoT device-2 (e.g., a device with a bandwidth of 1.4 MHz).

Based on the device type of a receiving device, the receiving device may determine the parameters to use for monitoring a CORESET. For example, the network node may transmit, and the receiving device may receive, an SSB that includes an MIB. Accordingly, a field of the MIB may include a set of bits that indicates an index from the set of indexes included in the table of example 1700. Accordingly, based on the received index and the device type of the receiving device, the receiving device can determine parameters to use for monitoring a CORESET, such as a number of RBs for the CORESET (e.g., bandwidth 620), a number of symbols for the CORESET (e.g., duration 615), and an RB offset relative to a reference RB (e.g., reference RB 1335).

For instance, in one example, the network node may transmit, and multiple UEs may receive, an SSB that includes an MIB, where the MIB indicates index 3 from the table of example 1700. Additionally, in the one example, the SCS=15 kHz, the k_SSB is common across all CORESET configurations, L=6 for the CCE-to-REG mapping, and the reference RB is the lowest CRB overlapping with the lowest RB of the SSB. A first UE of the multiple UEs is of device type 1705, and may therefore monitor for the CORESET0. Accordingly, the first UE determines that the CORESET for monitoring is configured with 24 RBs, 2 symbols, and an RB offset relative to the lowest RB of the SSB of 2. A second UE of the multiple UEs is of device type 1710, and may therefore monitor for the CORESET0a. Accordingly, the second UE determines that the CORESET for monitoring is configured with 15 RBs, 6 symbols, and an RB offset relative to the lowest RB of the SSB of −2. A third UE of the multiple UEs is of device type 1715, and may therefore monitor for the CORESET0b. Accordingly, the third UE determines that the CORESET for monitoring is configured with 6 RBs, 6 symbols, and an RB offset relative to the lowest RB of the SSB of −4 or −10 with a changing pattern 1 (e.g., as described according to example 1400).

The table of example 1700 is an example table. In other examples, the entries of the table may be different than those of example 1700, according to the various techniques provided herein. Additionally, the table of example 1700 may be for CORESET configurations for a set of RBs and slot symbols of CORESET for Type0-PDCCH search space set when {SS/PBCH block, PDCCH} SCS is {15, 15} kHz for frequency bands with minimum channel bandwidth 5 MHz. Accordingly, the UEs may be preconfigured with multiple tables (e.g., as part of the OEM configuration) used for identifying parameters of a CORESET configuration for different combinations of SS/PBCH and PDCCH SCSs and for different frequency channel bandwidths. Additionally, or alternatively, the table of example 1700 may include other entries that configure any of the other parameters for configuring CORESET0, CORESET0a, and CORESET0b as provided herein. Additionally, or alternatively, the table of example 1700 may include more or fewer indexes than those shown in FIG. 17.

According to example 1700, implementation of the table minimizes the signaling overhead within the MIB, thus reducing the need for extensive configuration signaling. Additionally, to provide flexibility and adaptability in configuring these multiple CORESETs, different entries are defined within the MIB to jointly indicate the configurations for CORESET0, CORESET0a, and CORESET0b. This approach allows for a streamlined and efficient method of conveying configuration parameters (such as number of RBs, number of symbols, and an RB offset), without burdening the MIB with excessive signaling. By utilizing indexed entries, the MIB can effectively communicate the multiple sets of parameters for multiple CORESET configurations, ensuring that UEs of different bandwidth capabilities can quickly and accurately interpret the control information, leading to optimized network performance and enhanced communication reliability across diverse deployment scenarios.

As indicated above, FIG. 17 is provided as an example. Other examples may differ from what is described with regard to FIG. 17.

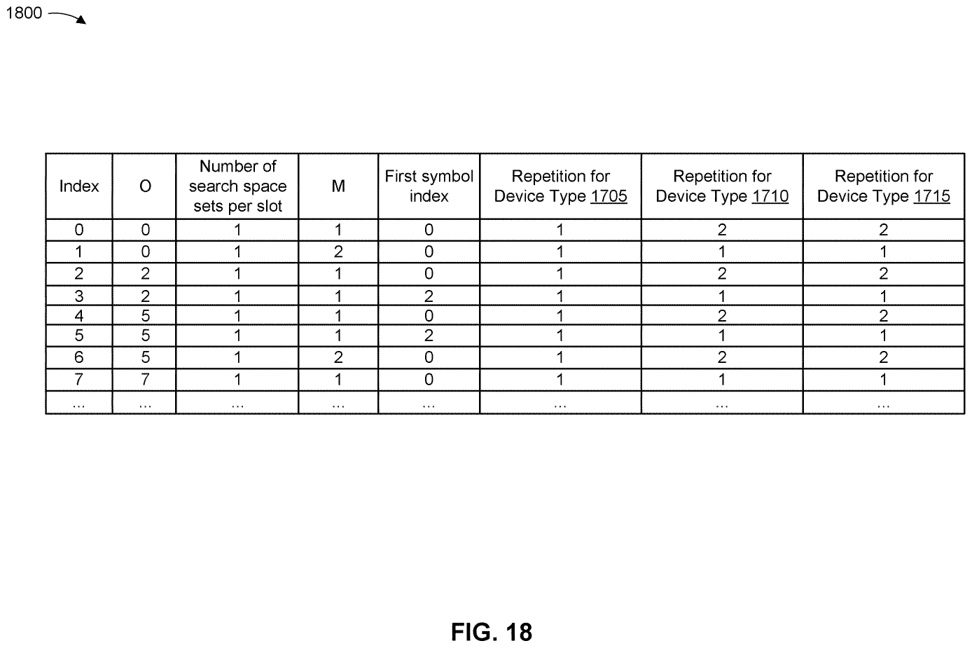

FIG. 18 is a diagram illustrating an example 1800 associated with different entries of a MIB indication to jointly indicate different search space configurations. Example 1800 may implement or be implemented by one or more aspects of wireless communication network 100 and examples 200 through 1700.

In the configuration of search spaces SS0, SS0a, and SS0b (respectively mapped to CORESET0, CORESET0a, and CORESET0b), the MIB may include signaling to convey the configuration parameters for the different search spaces. To streamline this process and reduce signaling overhead within the MIB, certain parameters for SS0, SS0a, and SS0b may be predefined. This predefined approach minimizes the extensive signaling, allowing for more efficient use of the MIB capacity. However, to accommodate for the configuration of different search spaces, the MIB can include different entries that jointly indicate the configurations for SS0, SS0a, and SS0b.

For instance, while SS0, SS0a, and SS0b may share common parameters such as symbol, slot, and SFN indices, as well as periodicity, the different search spaces differ in terms of slot-level repetitions. For instance, the table in example 1800 jointly indicates for SS0, SS0a, and SS0b a parameter O (e.g., represents an offset value, and used to determine the starting point or reference for slot numbering within the frame), a parameter M (e.g., represents the periodicity or the number of slots in a repeating pattern), a first symbol index (i) (e.g., denotes an index or iteration variable), and a number of search space sets per slot. Additionally, the slot index (no) for the location of a search space may be n₀=(O·2^{μ}+(i·M)mod N) (e.g., where μrepresents a scaling factor based on the SCS configuration). Additionally, the value of n₀ can be used to determine the SFNc index for the search spaces. For example, if n₀ mod 2=0, then SFN, mod (X/10)=0 and if n₀ mod 2=1, then SFN, mod (X/10)=1 (e.g., where X is the periodicity between SFNs).

In accordance with the table of example 1800, an index included in the MIB indicates a set of parameters jointly shared across different device types. Additionally, the index included in the MIB indicates a respective repetition of a search space configured for different device types. For example, the index included in the MIB indicates a first repetition for SS0 corresponding to the device type 1705 (e.g., the eMBB device-0), indicates a second repetition for SS0a corresponding to the device type 1710 (e.g., the IoT device-1), and a third repetition for SS0b corresponding to the device type 1715 (e.g., the IoT device-2).

The table of example 1800 is an example table. In other examples, the values of the table may be different than those of example 1800, according to the various techniques provided herein. Additionally, the table of example 1800 may be for search space configurations for defining PDCCH MOs for Type0-PDCCH CSS set-SS/PBCH block and CORESET multiplexing pattern 1 and FR1. Accordingly, UEs may be preconfigured with multiple tables (e.g., as part of the OEM configuration) used for identifying parameters of search space configurations for different combinations of multiplexing patterns and frequency ranges. Additionally, or alternatively, the table of example 1800 may include other entries that indicate any of the other parameters for configuring PDCCH MOs as provided herein. Additionally, or alternatively, the table of example 1800 may include more or fewer indexes than are shown in FIG. 18.

By defining different entries within the MIB for joint search space configurations, the network can effectively communicate these variations in configuration, ensuring that each search space is tailored to its intended purpose. This joint indication approach allows for a cohesive and efficient method of conveying the search space configurations, enabling UEs of varying bandwidth capability to accurately interpret and respond to the control information. As a result, the network can maintain optimized performance and reliable communication across various deployment scenarios, supporting diverse device types and use cases while minimizing the signaling burden on the MIB.

As indicated above, FIG. 18 is provided as an example. Other examples may differ from what is described with regard to FIG. 18.

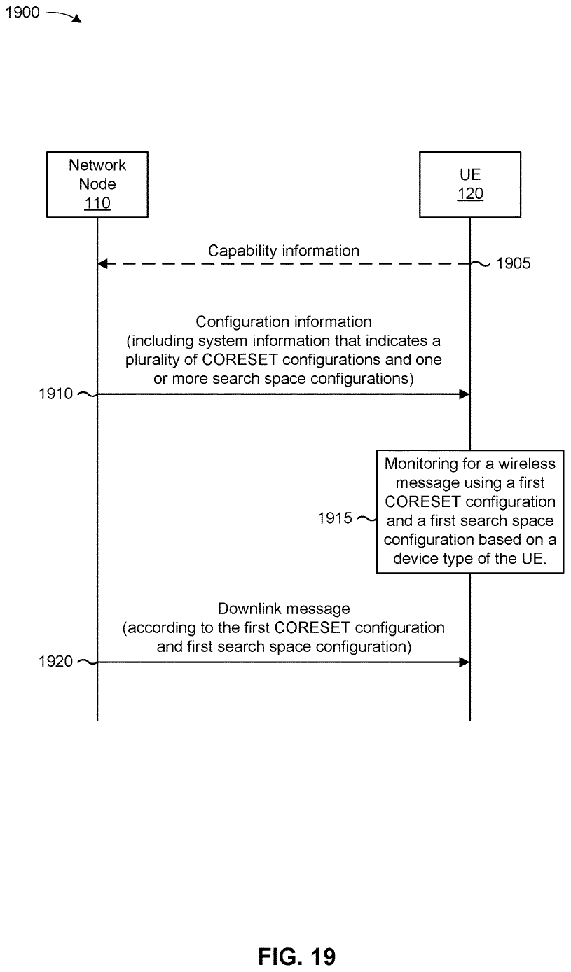

FIG. 19 is a diagram of an example 1900 associated with signaling that enables CORESET and search space configurations for different device types. As shown in FIG. 19, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 19. FIG. 19 depicts an example sequence of operations associated with the transmission and reception of capability information or configuration information to enable the network node 110 to allocate resources effectively and adapt to varying device types by exchanging capability details and system information, thereby optimizing communication efficiency and enhancing user connectivity experience through appropriate CORESET and search space configurations.

In some aspects, as shown by reference number 1905, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for supported frequency bands and transmission power levels. As another example, the capability information may indicate a capability or parameter for CORESET configurations and search space configurations used for various device types. For instance, the UE 120 may indicate a device type of the UE 120 (e.g., one of eMBB device-0, IoT device-1, or IoT device-2) or may indicate a bandwidth capability for receiving wireless messages (e.g., one of bandwidth ≥5 MHz, bandwidth=3 MHz, or bandwidth=1.4 MHz, among other examples). One or more operations described herein may be based on capability information. For example, the UE 120 may perform a communication in accordance with the capability information, or may receive configuration information that is in accordance with the capability information. In some aspects, the capability information may indicate UE 120 support for one or more of common and device-specific MOs, SCS options, RB offsets, CCE interleaving patterns, precoding schemes, or aggregation levels configured for CORESET configurations.

As shown by reference number 1910, the network node 110 may transmit, and the UE 120 may receive, configuration information. In some aspects, the UE 120 may receive the configuration information via one or more of system information signaling (e.g., a MIB or a SIB, among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node 110 or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an OEM configuration). For instance, the UE 120 may store one or more tables including the information corresponding to the table of example 1700, to the table of example 1800, or both. In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to receive system information (e.g., as part of an SSB) that indicates a plurality of CORESET configurations and one or more search space configurations for various device types, and monitor for a wireless message using a first CORESET configuration from the plurality of CORESET configurations and a first search space configuration based on the device type. These operations enable the UE 120 to communicate its capabilities, adapt to diverse network conditions and device-specific requirements, and efficiently process incoming messages, thereby optimizing network resource allocation and enhancing communication efficiency and reliability.

The UE 120 may configure itself based on the configuration information. In some aspects, the UE 120 may be configured to perform one or more operations described herein based at least in part on the configuration information.

In some aspects, the UE 120 may receive as part of the configuration information, from a network node 110, system information that indicates a plurality of CORESET configurations (e.g., CORESET0, CORESET0a, and CORESET0b) and one or more search space configurations (e.g., a common search space across CORESET0, CORESET0a, and CORESET0b or one or more of SS0, SS0a, or SS0b) that are both used for a plurality of device types. For example, the network node 110 may provide the UE 120 with a list of CORESET configurations applicable for smartphones, tablets, and IoT devices. In this way, receiving system information with multiple configurations may allow the UE 120 to adapt to different network conditions and device-specific requirements, thus enhancing connectivity and user experience.

In some aspects, the plurality of CORESET configurations and the one or more search space configurations may indicate a plurality of MOs that are common across the plurality of device types (e.g., as provided with reference to example 800a). For example, a shared monitoring schedule may be distributed to various devices within a network to ensure synchronized operations. Having common MOs across device types may streamline network management and reduce complexity in scheduling.

Additionally, or alternatively, the plurality of CORESET configurations and the one or more search space configurations may indicate a plurality of MOs that are respectively associated with the plurality of device types (e.g., as provided with reference to example 800b and 800c). Associating MOs with specific device types may enhance efficiency by tailoring operations to the capabilities and needs of each device type.

Additionally, or alternatively, the plurality of CORESET configurations and the one or more search space configurations may indicate a plurality of MOs, where a first subset of the plurality of MOs are common across the plurality of device types, and a second subset of the plurality of MOs are respectively associated with the plurality of device types (e.g., as provided with reference to example 900). This dual approach may optimize network resources while ensuring that device-specific needs are met.

In some aspects, the plurality of CORESET configurations may be aligned with a CRB based on the system information indicating a subcarrier offset relative to a subcarrier of an SSB (e.g., as provided with reference to example 1000). For example, a consistent alignment may be established across devices to facilitate easier network synchronization. Aligning CORESET configurations in this manner may reduce the complexity of frequency management in network operations.

Additionally, or alternatively, the plurality of CORESET configurations may not be aligned with a CRB based on the system information indicating a second subcarrier offset for the plurality of CORESET configurations that is different than a first subcarrier offset relative to a subcarrier of an SSB (e.g., as provided with reference to example 1100). For example, certain devices may receive individualized alignment adjustments to accommodate specific operational requirements. Such flexibility in subcarrier alignment may enhance overall network performance by catering to diverse device needs.

In some aspects, the plurality of CORESET configurations may share a same SCS (e.g., as provided with reference to example 1200a). For example, a uniform SCS may be maintained for different device types to promote consistent data throughput. Sharing the same SCS across configurations may simplify network design and implementation.

Additionally, or alternatively, the plurality of CORESET configurations may have different SCSs (e.g., as provided with reference to example 1200b). For example, varying SCSs may be used to optimize data transfer rates for high-bandwidth applications versus low-bandwidth ones. Different SCSs may provide the versatility for catering to diverse operational requirements.

In some aspects, the system information may indicate an RB offset for the plurality of CORESET configurations relative to one or more reference RBs (e.g., as provided with reference to example 1300). Specifying RB offsets may help manage network load and minimize interference.

In some aspects, a CCE-to-REG interleaving pattern for the plurality of CORESET configurations may be a non-interleaving pattern. For example, a straightforward mapping may be applied to simplify the extraction process for certain types of devices. Using a non-interleaving pattern may reduce computational overhead during signal processing.

Additionally, or alternatively, the CCE-to-REG interleaving pattern for the plurality of CORESET configurations may be an interleaving pattern across a full frequency range configured for the plurality of CORESET configurations (e.g., as provided with reference to example 1500a). For example, interleaving may be employed to enhance the robustness of data transmission across a wide frequency band. This pattern may be used to increase resilience to frequency-selective fading.

Additionally, or alternatively, a CCE-to-REG interleaving pattern for the plurality of CORESET configurations may be an interleaving pattern across a plurality of frequency ranges configured for the plurality of CORESET configurations (e.g., as provided with reference to example 1500b). For example, multiple interleaving patterns may be used to cater to different frequency bands used by various devices. Such patterns may enhance communication reliability by providing redundancy across multiple frequencies.

In some aspects, a precoding scheme configured for the plurality of CORESET configurations may be an REG-bundle precoding scheme (e.g., as provided with reference to example 1600). For example, grouping resource elements for precoding may simplify the processing required by the UE 120. This scheme may improve the efficiency of signal processing by minimizing the complexity of precoding operations.

Additionally, or alternatively, a precoding scheme configured for the plurality of CORESET configurations may be a wideband precoding scheme (e.g., as provided with reference to example 1600). For example, wideband precoding may be used to address the needs of devices that operate over extensive frequency bands. This approach may enhance data rates by optimizing the use of available spectrum.

In some aspects, the plurality of CORESET configurations may comprise a CORESET0 configuration, a CORESET0a configuration, and a CORESET0b configuration, where the CORESET0a configuration and the CORESET0b configuration have a longer duration than the CORESET0 configuration (e.g., as provided with reference to example 1600). For example, different configurations may be leveraged to support longer transmissions or accommodate varying data payloads. This differentiation in duration may enable tailored transmission strategies based on specific data requirements.

In some aspects, the plurality of CORESET configurations may share a same CCE-to-REG bundle unit (e.g., as provided with reference to example 1600). For example, a consistent bundle unit may be employed to streamline processing across similar devices. Sharing a common bundle unit may simplify resource management across the network.

Additionally, or alternatively, the plurality of CORESET configurations may be respectively configured with a plurality of CCE-to-REG bundle units (e.g., as provided with reference to example 1600). For example, different bundle units may be assigned to accommodate the specific operational needs of various device types. This approach may enable precise control over resource allocation and usage.

In some examples, a link budget requirement, which determines the signal strength for reliable communication, may vary among eMBB device-0, IoT device-1, and IoT device-2, reflecting distinct operational needs and capabilities for each type of device. Similarly, the minimum coupling loss (MCL) for coverage enhancement, which influences a device ability to maintain a connection in challenging environments, may differ for each device type. For instance, eMBB device-0 may be equipped with dual receivers (e.g., 2Rx) to enhance signal reception, while IoT device-1 and IoT device-2 may operate with a single receiver (e.g., 1Rx), indicating a trade-off between performance and complexity.

Given the varying link budget requirements, MCL, and receiver configurations among eMBB device-0, IoT device-1, and IoT device-2, different configurations may be applied to CORESET0, CORESET0a, CORESET0b, and their corresponding search spaces SS0, SS0a, and SS0b to optimize performance for each device type. Specifically, the AL range for PDCCH candidates can differ, with CORESET0 potentially using AL values of 4, 8, and 16, while CORESET0a and CORESET0b may utilize higher AL values of 8, 16, and 32, reflecting the need for more robust control signaling for devices with different operational requirements.

Additionally, or alternatively, to accommodate the distinct communication characteristics of among eMBB device-0, IoT device-1, and IoT device-2, PDCCH repetitions for CORESET0, CORESET0a, and CORESET0b may vary and can be predefined or configured via the MIB of the system information. For example, CORESET0 may have a single PDCCH repetition, ensuring straightforward control signaling for devices with higher link budgets. In contrast, CORESET0a and CORESET0b may employ more complex repetition schemes, such as intra-slot repetition of 2 and inter-slot repetitions of 1, 2, or 4, to enhance signal robustness and reliability for devices operating under more challenging conditions or with lower link budgets.

Additionally, or alternatively, in scenarios where the network node 110 has not provided the UE 120 with dedicated higher layer parameters, the UE 120 may determine different transmission power ratios for CORESET0, CORESET0a, and CORESET0b when monitoring PDCCHs for a DCI format 1_0 with CRC scrambled by SI-RNTI, P-RNTI, or RA-RNTI. For CORESET0, the ratio of PDCCH DMRS per EPRE to SSS EPRE may range between −8 dB and 8 dB. In contrast, for CORESET0a and CORESET0b, this range may extend from −11 dB to 11 dB, reflecting the potential for more power boosting to accommodate the enhanced coverage of IoT device-1 and IoT device-2.

In some aspects, the plurality of CORESET configurations may be respectively configured with a plurality of aggregation levels, the plurality of CORESET configurations may be respectively configured with a plurality of physical downlink control channel repetitions, and the plurality of CORESET configurations may be respectively configured with a plurality of communication power ratios. For example, varying these parameters may optimize performance for devices with diverse capabilities and use cases. Additionally, such parameters may be preconfigured (e.g., via OEM configuration) or configured via the MIB of the system information.

In some aspects, the system information may include a set of bits that jointly indicates multiple parameters per CORESET configuration of the plurality of CORESET configurations (e.g., as provided with reference to example 1700). For example, the multiple parameters may at least include an SSB and CORESET multiplexing pattern, a number of RBs per CORESET configuration, a number of symbols per CORESET configuration, and one or more RB offsets per CORESET configuration. For example, a compact bit sequence may convey detailed configuration information for multiple CORESETs. Such a comprehensive indication may enable efficient configuration management by minimizing the signaling overhead.

Additionally, or alternatively, the system information may include a set of bits that jointly indicates multiple parameters per search space configuration of the one or more search space configurations (e.g., as provided with reference to example 1800). For example, the multiple parameters may at least include a starting slot offset within a frame, a number of search space sets per slot, a number of slots in a repeating pattern, a starting symbol index, and a number of repetitions per search space configuration. For example, this encoding may specify the temporal and spatial characteristics of search space configurations for diverse devices. Providing such detailed information in a compact form may facilitate rapid deployment of network resources in a dynamic wireless environment.

In some aspects, as shown by reference number 1915, the UE 120 may monitor for a wireless message using a first CORESET configuration from the plurality of CORESET configurations and a first search space configuration from the one or more search space configurations based on a device type of the UE 120 from the plurality of device types. In this way, monitoring with appropriate configurations may ensure efficient processing of incoming messages and improve the reliability of communication.

In some aspects, the first CORESET configuration may comprise a CORESET0b configuration, and therefore the UE 120 may monitor, during a first CORESET MO, a first portion of a CORESET configuration in accordance with a first RB offset that is relative to a reference RB of the CORESET0 configuration monitor, and during a second CORESET MO, a second portion of a CORESET0 configuration in accordance with a second RB offset that is relative to the reference RB of the CORESET0 configuration (e.g., as provided with reference to example 1400). For example, the UE 120 may adjust its monitoring strategy to account for the different offsets during successive monitoring periods. This approach may ensure detection and decoding of control information. Additionally, or alternatively, the first RB offset and the second RB offset may be part of an RB offset changing pattern configured for the CORESET0b configuration. For example, the UE 120 may follow a pre-defined pattern that adjusts offsets to optimize resource usage during monitoring. Implementing an offset changing pattern may enhance the adaptability of the UE 120 to varying network conditions.

In some aspects, as shown by reference number 1920, the network node 110 may transmit, and the UE 120 may receive, a downlink message using the first CORESET configuration and the first search space configuration. In this way, utilizing the first CORESET and search space configurations may optimize the transmission process and minimize latency in receiving critical updates.

As indicated above, FIG. 19 is provided as an example. Other examples may differ from what is described with regard to FIG. 19.

FIG. 20 is a diagram illustrating an example process 2000 performed, for example, at a UE or an apparatus of a UE. Example process 2000 is an example where the apparatus or the UE (e.g., UE 120) performs operations associated with control resource set and search space configurations for different device types.

As shown in FIG. 20, in some aspects, process 2000 may include receiving, from a network node, system information that indicates a plurality of CORESET configurations and one or more search space configurations that are both used for a plurality of device types (block 2010). For example, the UE (e.g., using reception component 2202 or communication manager 2206, depicted in FIG. 22) may receive, from a network node, system information that indicates a plurality of CORESET configurations and one or more search space configurations that are both used for a plurality of device types, as described above.

As further shown in FIG. 20, in some aspects, process 2000 may include receiving, from the network node, a message using a first CORESET configuration from the plurality of CORESET configurations and a first search space configuration from the one or more search space configurations based at least in part on a device type of the UE from the plurality of device types (block 2020). For example, the UE (e.g., using reception component 2202 or communication manager 2206, depicted in FIG. 22) may receive, from the network node, a message using a first CORESET configuration from the plurality of CORESET configurations and a first search space configuration from the one or more search space configurations based at least in part on a device type of the UE from the plurality of device types, as described above.

Process 2000 may include additional aspects, such as any single aspect or any combination of aspects described below or in connection with one or more other processes described elsewhere herein.

In a first aspect, the plurality of CORESET configurations and the one or more search space configurations indicate a plurality of MOs that are common across the plurality of device types.

In a second aspect, alone or in combination with the first aspect, the plurality of CORESET configurations and the one or more search space configurations indicate a plurality of MOs that are respectively associated with the plurality of device types.

In a third aspect, alone or in combination with one or more of the first and second aspects, the plurality of CORESET configurations and the one or more search space configurations indicate a plurality of MOs, where a first subset of the plurality of MOs are common across the plurality of device types, and a second subset of the plurality of MOs are respectively associated with the plurality of device types.

In a fourth aspect, alone or in combination with one or more of the first through third aspects, the plurality of CORESET configurations are aligned with a CRB based at least in part on the system information indicating a subcarrier offset relative to a subcarrier of a SSB.

In a fifth aspect, alone or in combination with one or more of the first through fourth aspects, the plurality of CORESET configurations are not aligned with a CRB based at least in part on the system information indicating a second subcarrier offset for the plurality of CORESET configurations that is different than a first subcarrier offset relative to a subcarrier of a SSB.

In a sixth aspect, alone or in combination with one or more of the first through fifth aspects, the plurality of CORESET configurations share a same SCS.

In a seventh aspect, alone or in combination with one or more of the first through sixth aspects, the plurality of CORESET configurations have different SCSs.

In an eighth aspect, alone or in combination with one or more of the first through seventh aspects, the system information indicates an RB offset for the plurality of CORESET configurations relative to one or more reference RBs.

In a ninth aspect, alone or in combination with one or more of the first through eighth aspects, the first CORESET configuration comprises a CORESET0b configuration, and the process 2000 further includes monitoring, during a first CORESET MO, a first portion of a CORESET0 configuration in accordance with a first RB offset that is relative to a reference RB of the CORESET0 configuration, and monitoring, during a second CORESET MO, a second portion of a CORESET0 configuration in accordance with a second RB offset that is relative to the reference RB of the CORESET0 configuration.

In a tenth aspect, alone or in combination with one or more of the first through ninth aspects, the first RB offset and the second RB offset are part of an RB offset changing pattern configured for the CORESET0b configuration.

In an eleventh aspect, alone or in combination with one or more of the first through tenth aspects, a CCE-to-REG interleaving pattern for the plurality of CORESET configurations is a non-interleaving pattern.

In a twelfth aspect, alone or in combination with one or more of the first through eleventh aspects, a controlling channel element to REG interleaving pattern for the plurality of CORESET configurations is an interleaving pattern across a full frequency range configured for the plurality of CORESET configurations.

In a thirteenth aspect, alone or in combination with one or more of the first through twelfth aspects, a CCE-to-REG interleaving pattern for the plurality of CORESET configurations is an interleaving pattern across a plurality of frequency ranges configured for the plurality of CORESET configurations.

In a fourteenth aspect, alone or in combination with one or more of the first through thirteenth aspects, a precoding scheme configured for the plurality of CORESET configurations is an REG bundle precoding scheme.

In a fifteenth aspect, alone or in combination with one or more of the first through fourteenth aspects, a precoding scheme configured for the plurality of CORESET configurations is a wideband precoding scheme.

In a sixteenth aspect, alone or in combination with one or more of the first through fifteenth aspects, the plurality of CORESET configurations comprise a CORESET0 configuration, a CORESET0a configuration, and a CORESET0b configuration, and the CORESET0a configuration and the CORESET0b configuration have a longer duration than the CORESET0 configuration. The CORESET0a/0b may be configured to be associated with intra-slot and/or inter-slot repetitions, and DMRS bundling to improve the PDCCH coverage.

In a seventeenth aspect, alone or in combination with one or more of the first through sixteenth aspects, the plurality of CORESET configurations comprise share a same CCE-to-REG bundle unit.

In an eighteenth aspect, alone or in combination with one or more of the first through seventeenth aspects, the plurality of CORESET configurations are respectively configured with a plurality of CCE-to-REG bundle units.

In a nineteenth aspect, alone or in combination with one or more of the first through eighteenth aspects, the plurality of CORESET configurations are respectively configured with a plurality of aggregation levels, the plurality of CORESET configurations are respectively configured with a plurality of physical downlink control channel repetitions, and the plurality of CORESET configurations are respectively configured with a plurality of communication power ratios.

In a twentieth aspect, alone or in combination with one or more of the first through nineteenth aspects, the system information includes a set of bits that jointly indicates multiple parameters per CORESET configuration of the plurality of CORESET configurations, and the multiple parameters at least include a synchronization signal block and CORESET multiplexing pattern, a number of RBs per CORESET configuration, a number of symbols per CORESET configuration, and one or more RB offsets per CORESET configuration.

In a twenty-first aspect, alone or in combination with one or more of the first through twentieth aspects, the system information includes a set of bits that jointly indicates multiple parameters per search space configuration of the one or more search space configurations, and the multiple parameters at least include a starting slot offset within a frame, a number of search space sets per slot, a number of slots in a repeating pattern, a starting symbol index, and a number of repetitions per search space configuration.

In a twenty-second aspect, alone or in combination with one or more of the first through twenty-first aspects, the plurality of CORESET configurations comprise a CORESET0 configuration, a CORESET0a configuration, and a CORESET0b configuration, and wherein physical downlink control channel repetitions associated with the CORESET0a configuration and the CORESET0b configuration are different from physical downlink control channel repetitions associated with the CORESET0 configuration.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, at a network node or an apparatus of a network node. Example process 2100 is an example where the apparatus or the network node (e.g., network node 110) performs operations associated with control resource set and search space configurations for different device types.

As shown in FIG. 21, in some aspects, process 2100 may include transmitting, to a UE, system information that indicates a plurality of CORESET configurations and one or more search space configurations that are both used for a plurality of device types (block 2110). For example, the network node (e.g., using transmission component 2304 or communication manager 2306, depicted in FIG. 23) may transmit, to a UE, system information that indicates a plurality of CORESET configurations and one or more search space configurations that are both used for a plurality of device types, as described above.

As further shown in FIG. 21, in some aspects, process 2100 may include transmitting, to the UE, a message using a first CORESET configuration from the plurality of CORESET configurations and a first search space configuration from the one or more search space configurations based at least in part on a device type of the UE from the plurality of device types (block 2120). For example, the network node (e.g., using transmission component 2304 or communication manager 2306, depicted in FIG. 23) may transmit, to the UE, a message using a first CORESET configuration from the plurality of CORESET configurations and a first search space configuration from the one or more search space configurations based at least in part on a device type of the UE from the plurality of device types, as described above.

Process 2100 may include additional aspects, such as any single aspect or any combination of aspects described below or in connection with one or more other processes described elsewhere herein.

In a first aspect, the plurality of CORESET configurations and the one or more search space configurations indicate a plurality of MOs that are common across the plurality of device types.

In a second aspect, alone or in combination with the first aspect, the plurality of CORESET configurations and the one or more search space configurations indicate a plurality of MOs that are respectively associated with the plurality of device types.

In a third aspect, alone or in combination with one or more of the first and second aspects, the plurality of CORESET configurations and the one or more search space configurations indicate a plurality of MOs, where a first subset of the plurality of MOs are common across the plurality of device types, and a second subset of the plurality of MOs are respectively associated with the plurality of device types.

In a fourth aspect, alone or in combination with one or more of the first through third aspects, the plurality of CORESET configurations are aligned with a CRB based at least in part on the system information indicating a subcarrier offset relative to a subcarrier of a SSB.

In a fifth aspect, alone or in combination with one or more of the first through fourth aspects, the plurality of CORESET configurations are not aligned with a CRB based at least in part on the system information indicating a second subcarrier offset for the plurality of CORESET configurations that is different than a first subcarrier offset relative to a subcarrier of a SSB.

In a sixth aspect, alone or in combination with one or more of the first through fifth aspects, the plurality of CORESET configurations share a same SCS.

In a seventh aspect, alone or in combination with one or more of the first through sixth aspects, the plurality of CORESET configurations have different SCSs.

In an eighth aspect, alone or in combination with one or more of the first through seventh aspects, the system information indicates an RB offset for the plurality of CORESET configurations relative to one or more reference RBs.

In a ninth aspect, alone or in combination with one or more of the first through eighth aspects, a CCE-to-REG interleaving pattern for the plurality of CORESET configurations is a non-interleaving pattern.

In a tenth aspect, alone or in combination with one or more of the first through ninth aspects, a controlling channel element to REG interleaving pattern for the plurality of CORESET configurations is an interleaving pattern across a full frequency range configured for the plurality of CORESET configurations.

In an eleventh aspect, alone or in combination with one or more of the first through tenth aspects, a CCE-to-REG interleaving pattern for the plurality of CORESET configurations is an interleaving pattern across a plurality of frequency ranges configured for the plurality of CORESET configurations.

In a twelfth aspect, alone or in combination with one or more of the first through eleventh aspects, a precoding scheme configured for the plurality of CORESET configurations is a REG bundle precoding scheme.

In a thirteenth aspect, alone or in combination with one or more of the first through twelfth aspects, a precoding scheme configured for the plurality of CORESET configurations is a wideband precoding scheme.

In a fourteenth aspect, alone or in combination with one or more of the first through thirteenth aspects, the plurality of CORESET configurations comprise a CORESET0 configuration, a CORESET0a configuration, and a CORESET0b configuration, and the CORESET0a configuration and the CORESET0b configuration have a longer duration than the CORESET0 configuration. The CORESET0a/0b may be configured to be associated with intra-slot and/or inter-slot repetitions, and DMRS bundling to improve the PDCCH coverage.

In a fifteenth aspect, alone or in combination with one or more of the first through fourteenth aspects, the plurality of CORESET configurations comprise share a same CCE-to-REG bundle unit.

In a sixteenth aspect, alone or in combination with one or more of the first through fifteenth aspects, the plurality of CORESET configurations are respectively configured with a plurality of CCE-to-REG bundle units.

In a seventeenth aspect, alone or in combination with one or more of the first through sixteenth aspects, the plurality of CORESET configurations are respectively configured with a plurality of aggregation levels, the plurality of CORESET configurations are respectively configured with a plurality of physical downlink control channel repetitions, and the plurality of CORESET configurations are respectively configured with a plurality of communication power ratios.

In an eighteenth aspect, alone or in combination with one or more of the first through seventeenth aspects, the system information includes a set of bits that jointly indicates multiple parameters per CORESET configuration of the plurality of CORESET configurations, and the multiple parameters at least include a SSB and CORESET multiplexing pattern, a number of RBs per CORESET configuration, a number of symbols per CORESET configuration, and one or more RB offsets per CORESET configuration.

In a nineteenth aspect, alone or in combination with one or more of the first through eighteenth aspects, the system information includes a set of bits that jointly indicates multiple parameters per search space configuration of the one or more search space configurations, and the multiple parameters at least include a starting slot offset within a frame, a number of search space sets per slot, a number of slots in a repeating pattern, a starting symbol index, and a number of repetitions per search space configuration.

In a twentieth aspect, alone or in combination with one or more of the first through nineteenth aspects, the plurality of CORESET configurations comprise a CORESET0 configuration, a CORESET0a configuration, and a CORESET0b configuration, and wherein physical downlink control channel repetitions associated with the CORESET0a configuration and the CORESET0b configuration are different from physical downlink control channel repetitions associated with the CORESET0 configuration.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication. The apparatus 2200 may be a UE, or a UE may include the apparatus 2200. In some aspects, the apparatus 2200 includes a reception component 2202, a transmission component 2204, or a communication manager 2206, which may be in communication with one another (for example, via one or more buses or one or more other components). In some aspects, the communication manager 2206 is the communication manager 150 described in connection with FIG. 1. As shown, the apparatus 2200 may communicate with another apparatus 2208, such as a UE or a network node (such as a CU, a DU, an RU, or a base station), using the reception component 2202 and the transmission component 2204. The communication manager 2206 may be included in, or implemented via, a processing system (for example, the processing system 140 described in connection with FIG. 1) of the UE.

In some aspects, the apparatus 2200 may be configured to perform one or more operations described herein in connection with FIGS. 2 through 19. Additionally, or alternatively, the apparatus 2200 may be configured to perform one or more processes described herein, such as process 2000 of FIG. 20. In some aspects, the apparatus 2200 or one or more components shown in FIG. 22 may include one or more components of the UE described in connection with FIG. 1. Additionally, or alternatively, one or more components shown in FIG. 22 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications, and may provide the processed signals to the one or more other components of the apparatus 2200. In some aspects, the reception component 2202 may include one or more components of the UE described above in connection with FIG. 1, such as a radio, one or more RF chains, one or more transceivers, or one or more modems, each of which may in turn be coupled with one or more antennas of the UE.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications, and may transmit the processed signals to the apparatus 2208. In some aspects, the transmission component 2204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 2204 may be co-located with the reception component 2202.

The communication manager 2206 may support operations of the reception component 2202 or the transmission component 2204. For example, the communication manager 2206 may receive information associated with configuring reception of communications by the reception component 2202 or transmission of communications by the transmission component 2204. Additionally, or alternatively, the communication manager 2206 may generate or provide control information to the reception component 2202 or the transmission component 2204 to control reception or transmission of communications.

The reception component 2202 may receive, from a network node, system information that indicates a plurality of CORESET configurations and one or more search space configurations that are both used for a plurality of device types. The reception component 2202 may receive, from the network node, a message using a first CORESET configuration from the plurality of CORESET configurations and a first search space configuration from the one or more search space configurations based at least in part on a device type of the UE from the plurality of device types.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

FIG. 23 is a diagram of an example apparatus 2300 for wireless communication. The apparatus 2300 may be a network node, or a network node may include the apparatus 2300. In some aspects, the apparatus 2300 includes a reception component 2302, a transmission component 2304, or a communication manager 2306, which may be in communication with one another (for example, via one or more buses or one or more other components). In some aspects, the communication manager 2306 is the communication manager 155 described in connection with FIG. 1. As shown, the apparatus 2300 may communicate with another apparatus 2308, such as a UE or a network node (such as a CU, a DU, an RU, or a base station), using the reception component 2302 and the transmission component 2304. The communication manager 2306 may be included in, or implemented via, a processing system (for example, the processing system 145 described in connection with FIG. 1) of the network node.

In some aspects, the apparatus 2300 may be configured to perform one or more operations described herein in connection with FIGS. 2 through 19. Additionally, or alternatively, the apparatus 2300 may be configured to perform one or more processes described herein, such as process 2100 of FIG. 21. In some aspects, the apparatus 2300 or one or more components shown in FIG. 23 may include one or more components of the network node described in connection with FIG. 1. Additionally, or alternatively, one or more components shown in FIG. 23 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications, and may provide the processed signals to the one or more other components of the apparatus 2300. In some aspects, the reception component 2302 may include one or more components of the network node described above in connection with FIG. 1, such as a radio, one or more RF chains, one or more transceivers, or one or more modems, each of which may in turn be coupled with one or more antennas of the network node. In some aspects, the reception component 2302 or the transmission component 2304 may include or may be included in a network interface. The network interface may be configured to obtain or output signals for the apparatus 2300 via one or more communications links, such as a backhaul link, a midhaul link, or a fronthaul link.

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications, and may transmit the processed signals to the apparatus 2308. In some aspects, the transmission component 2304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 2304 may be co-located with the reception component 2302.

The communication manager 2306 may support operations of the reception component 2302 or the transmission component 2304. For example, the communication manager 2306 may receive information associated with configuring reception of communications by the reception component 2302 or transmission of communications by the transmission component 2304. Additionally, or alternatively, the communication manager 2306 may generate or provide control information to the reception component 2302 or the transmission component 2304 to control reception or transmission of communications.

The transmission component 2304 may transmit, to a UE, system information that indicates a plurality of CORESET configurations and one or more search space configurations that are both used for a plurality of device types. The transmission component 2304 may transmit, to the UE, a message using a first CORESET configuration from the plurality of CORESET configurations and a first search space configuration from the one or more search space configurations based at least in part on a device type of the UE from the plurality of device types.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

The following provides an overview of some Aspects of the present disclosure:

Aspect 1: A method of wireless communication performed by a user equipment (UE), comprising: receiving, from a network node, system information that indicates a plurality of control resource set (CORESET) configurations and one or more search space configurations that are both used for a plurality of device types; and receiving, from the network node, a message using a first CORESET configuration from the plurality of CORESET configurations and a first search space configuration from the one or more search space configurations based at least in part on a device type of the UE from the plurality of device types.

Aspect 2: The method of Aspect 1, wherein the plurality of CORESET configurations and the one or more search space configurations indicate a plurality of monitoring occasions that are common across the plurality of device types.

Aspect 3: The method of any of Aspects 1-2, wherein the plurality of CORESET configurations and the one or more search space configurations indicate a plurality of monitoring occasions that are respectively associated with the plurality of device types.

Aspect 4: The method of any of Aspects 1-3, wherein the plurality of CORESET configurations and the one or more search space configurations indicate a plurality of monitoring occasions, wherein a first subset of the plurality of monitoring occasions are common across the plurality of device types, and wherein a second subset of the plurality of monitoring occasions are respectively associated with the plurality of device types.

Aspect 5: The method of any of Aspects 1-4, wherein the plurality of CORESET configurations are aligned with a common resource block based at least in part on the system information indicating a subcarrier offset relative to a subcarrier of a synchronization signal block (SSB).

Aspect 6: The method of any of Aspects 1-5, wherein the plurality of CORESET configurations are not aligned with a common resource block based at least in part on the system information indicating a second subcarrier offset for the plurality of CORESET configurations that is different than a first subcarrier offset relative to a subcarrier of a synchronization signal block (SSB).

Aspect 7: The method of any of Aspects 1-6, wherein the plurality of CORESET configurations share a same subcarrier-spacing.

Aspect 8: The method of any of Aspects 1-7, wherein the plurality of CORESET configurations have different subcarrier-spacings.

Aspect 9: The method of any of Aspects 1-8, wherein the system information indicates a resource block offset for the plurality of CORESET configurations relative to one or more reference resource blocks.

Aspect 10: The method of any of Aspects 1-9, wherein the first CORESET configuration comprises a CORESET0b configuration, the method further comprising: monitoring, during a first CORESET monitoring occasion, a first portion of a CORESET0 configuration in accordance with a first resource block offset that is relative to a reference resource block of the CORESET0 configuration; and monitoring, during a second CORESET monitoring occasion, a second portion of a CORESET0 configuration in accordance with a second resource block offset that is relative to the reference resource block of the CORESET0 configuration.

Aspect 11: The method of Aspect 10, wherein the first resource block offset and the second resource block offset are part of a resource block offset changing pattern configured for the CORESET0b configuration.

Aspect 12: The method of any of Aspects 1-11, wherein a control channel element to resource element group interleaving pattern for the plurality of CORESET configurations is a non-interleaving pattern.

Aspect 13: The method of any of Aspects 1-12, wherein control channel element to resource element group interleaving pattern for the plurality of CORESET configurations is an interleaving pattern across a full frequency range configured for the plurality of CORESET configurations.

Aspect 14: The method of any of Aspects 1-13, wherein a control channel element to resource element group interleaving pattern for the plurality of CORESET configurations is an interleaving pattern across a plurality of frequency ranges configured for the plurality of CORESET configurations.

Aspect 15: The method of any of Aspects 1-14, wherein a precoding scheme configured for the plurality of CORESET configurations is a resource element group bundle precoding scheme.

Aspect 16: The method of any of Aspects 1-15, wherein a precoding scheme configured for the plurality of CORESET configurations is a wideband precoding scheme.

Aspect 17: The method of any of Aspects 1-16, wherein the plurality of CORESET configurations comprise a CORESET0 configuration, a CORESET0a configuration, and a CORESET0b configuration, and wherein the CORESET0a configuration and the CORESET0b configuration have a longer duration than the CORESET0 configuration.

Aspect 18: The method of any of Aspects 1-17, wherein the plurality of CORESET configurations comprise share a same control channel element to resource element group bundle unit.

Aspect 19: The method of any of Aspects 1-18, wherein the plurality of CORESET configurations are respectively configured with a plurality of control channel element to resource element group bundle units.

Aspect 20: The method of any of Aspects 1-19, wherein: the plurality of CORESET configurations are respectively configured with a plurality of aggregation levels, the plurality of CORESET configurations are respectively configured with a plurality of physical downlink control channel repetitions, and the plurality of CORESET configurations are respectively configured with a plurality of communication power ratios.

Aspect 21: The method of any of Aspects 1-20, wherein the system information includes a set of bits that jointly indicates multiple parameters per CORESET configuration of the plurality of CORESET configurations, and wherein the multiple parameters at least include: a synchronization signal block and CORESET multiplexing pattern, a number of resource blocks per CORESET configuration, a number of symbols per CORESET configuration, and one or more resource block offsets per CORESET configuration.

Aspect 22: The method of any of Aspects 1-21, wherein the system information includes a set of bits that jointly indicates multiple parameters per search space configuration of the one or more search space configurations, and wherein the multiple parameters at least include: a starting slot offset within a frame, a number of search space sets per slot, a number of slots in a repeating pattern, a starting symbol index, and a number of repetitions per search space configuration.

Aspect 23: A method of wireless communication performed by a network node, comprising: transmitting, to a user equipment (UE), system information that indicates a plurality of control resource set (CORESET) configurations and one or more search space configurations that are both used for a plurality of device types; and transmitting, to the UE, a message using a first CORESET configuration from the plurality of CORESET configurations and a first search space configuration from the one or more search space configurations based at least in part on a device type of the UE from the plurality of device types.

Aspect 24: The method of Aspect 23, wherein the plurality of CORESET configurations and the one or more search space configurations indicate a plurality of monitoring occasions that are common across the plurality of device types.

Aspect 25: The method of any of Aspects 23-24, wherein the plurality of CORESET configurations and the one or more search space configurations indicate a plurality of monitoring occasions that are respectively associated with the plurality of device types.

Aspect 26: The method of any of Aspects 23-25, wherein the plurality of CORESET configurations and the one or more search space configurations indicate a plurality of monitoring occasions, wherein a first subset of the plurality of monitoring occasions are common across the plurality of device types, and wherein a second subset of the plurality of monitoring occasions are respectively associated with the plurality of device types.

Aspect 27: The method of any of Aspects 23-26, wherein the plurality of CORESET configurations are aligned with a common resource block based at least in part on the system information indicating a subcarrier offset relative to a subcarrier of a synchronization signal block (SSB).

Aspect 28: The method of any of Aspects 23-27, wherein the plurality of CORESET configurations are not aligned with a common resource block based at least in part on the system information indicating a second subcarrier offset for the plurality of CORESET configurations that is different than a first subcarrier offset relative to a subcarrier of a synchronization signal block (SSB).

Aspect 29: The method of any of Aspects 23-28, wherein the plurality of CORESET configurations share a same subcarrier-spacing.

Aspect 30: The method of any of Aspects 23-29, wherein the plurality of CORESET configurations have different subcarrier-spacings.

Aspect 31: The method of any of Aspects 23-30, wherein the system information indicates a resource block offset for the plurality of CORESET configurations relative to one or more reference resource blocks.

Aspect 32: The method of any of Aspects 23-31, wherein a control channel element to resource element group interleaving pattern for the plurality of CORESET configurations is a non-interleaving pattern.

Aspect 33: The method of any of Aspects 23-32, wherein control channel element to resource element group interleaving pattern for the plurality of CORESET configurations is an interleaving pattern across a full frequency range configured for the plurality of CORESET configurations.

Aspect 34: The method of any of Aspects 23-33, wherein a control channel element to resource element group interleaving pattern for the plurality of CORESET configurations is an interleaving pattern across a plurality of frequency ranges configured for the plurality of CORESET configurations.

Aspect 35: The method of any of Aspects 23-34, wherein a precoding scheme configured for the plurality of CORESET configurations is a resource element group bundle precoding scheme.

Aspect 36: The method of any of Aspects 23-35, wherein a precoding scheme configured for the plurality of CORESET configurations is a wideband precoding scheme.

Aspect 37: The method of any of Aspects 23-36, wherein the plurality of CORESET configurations comprise a CORESET0 configuration, a CORESET0a configuration, and a CORESET0b configuration, and wherein the CORESET0a configuration and the CORESET0b configuration have a longer duration than the CORESET0 configuration.

Aspect 38: The method of any of Aspects 23-37, wherein the plurality of CORESET configurations comprise share a same control channel element to resource element group bundle unit.

Aspect 39: The method of any of Aspects 23-38, wherein the plurality of CORESET configurations are respectively configured with a plurality of control channel element to resource element group bundle units.

Aspect 40: The method of any of Aspects 23-39, wherein: the plurality of CORESET configurations are respectively configured with a plurality of aggregation levels, the plurality of CORESET configurations are respectively configured with a plurality of physical downlink control channel repetitions, and the plurality of CORESET configurations are respectively configured with a plurality of communication power ratios.

Aspect 41: The method of any of Aspects 23-40, wherein the system information includes a set of bits that jointly indicates multiple parameters per CORESET configuration of the plurality of CORESET configurations, and wherein the multiple parameters at least include: a synchronization signal block (SSB) and CORESET multiplexing pattern, a number of resource blocks per CORESET configuration, a number of symbols per CORESET configuration, and one or more resource block offsets per CORESET configuration.

Aspect 42: The method of any of Aspects 23-41, wherein the system information includes a set of bits that jointly indicates multiple parameters per search space configuration of the one or more search space configurations, and wherein the multiple parameters at least include: a starting slot offset within a frame, a number of search space sets per slot, a number of slots in a repeating pattern, a starting symbol index, and a number of repetitions per search space configuration.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

Aspect 50: A device comprising a processing system that includes one or more processors and one or more code-storing memories coupled with the one or more processors, the processing system configured to cause the device to perform the method of one or more of Aspects 1-42.

Aspect 51: A device comprising a processing system that includes processor circuitry and code-storing memory circuitry, the processing system configured to cause the device to perform the method of one or more of Aspects 1-42.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, system information that indicates a plurality of control resource set (CORESET) configurations and one or more search space configurations that are both used for a plurality of device types; and
receive, from the network node, a message using a first CORESET configuration from the plurality of CORESET configurations and a first search space configuration from the one or more search space configurations based at least in part on a device type of the UE from the plurality of device types.

2. The UE of claim 1, wherein the plurality of CORESET configurations and the one or more search space configurations indicate a plurality of monitoring occasions that are common across the plurality of device types.

3. The UE of claim 1, wherein the plurality of CORESET configurations and the one or more search space configurations indicate a plurality of monitoring occasions that are respectively associated with the plurality of device types.

4. The UE of claim 1, wherein the plurality of CORESET configurations and the one or more search space configurations indicate a plurality of monitoring occasions, wherein a first subset of the plurality of monitoring occasions are common across the plurality of device types, and wherein a second subset of the plurality of monitoring occasions are respectively associated with the plurality of device types.

5. The UE of claim 1, wherein the plurality of CORESET configurations are aligned with a common resource block based at least in part on the system information indicating a subcarrier offset relative to a subcarrier of a synchronization signal block (SSB).

6. The UE of claim 1, wherein the plurality of CORESET configurations are not aligned with a common resource block based at least in part on the system information indicating a second subcarrier offset for the plurality of CORESET configurations that is different than a first subcarrier offset relative to a subcarrier of a synchronization signal block (SSB).

7. The UE of claim 1, wherein the plurality of CORESET configurations share a same subcarrier-spacing.

8. The UE of claim 1, wherein the plurality of CORESET configurations have different subcarrier-spacings.

9. The UE of claim 1, wherein the system information indicates a resource block offset for the plurality of CORESET configurations relative to one or more reference resource blocks.

10. The UE of claim 1, wherein the first CORESET configuration comprises a CORESET0b configuration, the processing system further configured to cause the UE to:
monitor, during a first CORESET monitoring occasion, a first portion of a CORESET0 configuration in accordance with a first resource block offset that is relative to a reference resource block of the CORESET0 configuration; and
monitor, during a second CORESET monitoring occasion, a second portion of a CORESET0 configuration in accordance with a second resource block offset that is relative to the reference resource block of the CORESET0 configuration.

11. The UE of claim 1, wherein a control channel element to resource element group interleaving pattern for the plurality of CORESET configurations is a non-interleaving pattern.

12. The UE of claim 1, wherein control channel element to resource element group interleaving pattern for the plurality of CORESET configurations is an interleaving pattern across a full frequency range configured for the plurality of CORESET configurations.

13. The UE of claim 1, wherein a control channel element to resource element group interleaving pattern for the plurality of CORESET configurations is an interleaving pattern across a plurality of frequency ranges configured for the plurality of CORESET configurations.

14. The UE of claim 1, wherein a precoding scheme configured for the plurality of CORESET configurations is a resource element group bundle precoding scheme.

15. The UE of claim 1, wherein a precoding scheme configured for the plurality of CORESET configurations is a wideband precoding scheme.

16. The UE of claim 1, wherein the plurality of CORESET configurations comprise a CORESET0 configuration, a CORESET0a configuration, and a CORESET0b configuration, and wherein the CORESET0a configuration and the CORESET0b configuration have a longer duration than the CORESET0 configuration.

17. The UE of claim 1, wherein the plurality of CORESET configurations comprise a CORESET0 configuration, a CORESET0a configuration, and a CORESET0b configuration, and wherein physical downlink control channel repetitions associated with the CORESET0a configuration and the CORESET0b configuration are different from physical downlink control channel repetitions associated with the CORESET0 configuration.

18. The UE of claim 1, wherein the system information includes a set of bits that jointly indicates multiple parameters per CORESET configuration of the plurality of CORESET configurations, and wherein the multiple parameters at least include:
a synchronization signal block and CORESET multiplexing pattern,
a number of resource blocks per CORESET configuration,
a number of symbols per CORESET configuration, and
one or more resource block offsets per CORESET configuration.

19. A method of wireless communication performed by a user equipment (UE), comprising:
receiving, from a network node, system information that indicates a plurality of control resource set (CORESET) configurations and one or more search space configurations that are both used for a plurality of device types; and
receiving, from the network node, a message using a first CORESET configuration from the plurality of CORESET configurations and a first search space configuration from the one or more search space configurations based at least in part on a device type of the UE from the plurality of device types.

20. An apparatus for wireless communication, comprising:
means for receiving, from a network node, system information that indicates a plurality of control resource set (CORESET) configurations and one or more search space configurations that are both used for a plurality of device types; and
means for receiving, from the network node, a message using a first CORESET configuration from the plurality of CORESET configurations and a first search space configuration from the one or more search space configurations based at least in part on a device type of the apparatus from the plurality of device types.
